(19) United States
(12) Patent Application Publication
(10) Pub. No.: US 2024/0340312 A1
(43) Pub. Date: Oct. 10, 2024

(54) MACHINE LEARNING SYSTEM FOR AUTOMATED DETECTION OF SUSPICIOUS DIGITAL IDENTIFIERS

(71) Applicant: Lookout, Inc., Boston, MA (US)

(72) Inventors: Aungon Nag Radon, Toronto (CA); Brian James Buck, Livermore, CA (US); Fatin Ridwan Haque, Kitchener (CA)

(21) Appl. No.: 18/295,766

(22) Filed: Apr. 4, 2023

(51) Int. Cl. H04L 9/40

(52) U.S. Cl. CPC H04L 63/1483; H04L 63/1408

(57) ABSTRACT

A machine learning system for providing automated detection of suspicious digital identifiers is disclosed. The system receives a request to determine if an identifier associated with a resource attempting to be accessed by a device is suspicious. In response to the request, the system selects a machine learning model and loads or computes features associated with the address to facilitate determination regarding suspiciousness of the digital identifier. The system executes the machine learning model utilizing the features to determine whether the digital identifier is suspicious. The determination regarding suspiciousness of the digital identifier is provided to a phishing and content protection classifier to persist the response in a database. The determination may be verified by an expert and may be utilized to prevent access to the resource associated with the identifier and to train the machine learning model to enhance future determinations relating to suspiciousness of digital identifiers.

### FIELD OF THE TECHNOLOGY

At least some embodiments disclosed herein relate to machine learning technologies, cybersecurity technologies, intrusion detection technologies, network technologies, and more particularly, but not limited to, a machine learning system for providing automated detection of suspicious digital identifiers.

### BACKGROUND

With society becoming increasingly reliant on technology to conduct business, communications, and other activities, the various forms of technologies that facilitate such activities have become increasingly under attack by malicious actors. Malicious actors deploy a variety of cyberattacks including, but not limited to, denial-of-service attacks, phishing attacks, spoofing attacks, social engineering attacks, malware attacks, zero-day exploits, among other attacks to gain control of accounts, financial resources, identities, and the like. As a specific example, phishing attacks, which often involve the use of suspicious uniform resource locators (URLs) or fully qualified domain names (FQDNs) to deceive users, are some of the most common mechanisms that malicious actors use to execute a cyberattack. A URL, for example, may be a web address that serves as a reference to a resource (e.g., web resource) that specifies the resource's location on a communications network and the mechanism by which the resource is accessed or retrieved. An exemplary URL would be http://www[.]exampleurl[.]com/index.html, where http indicates the protocol, www[.]exampleurl[.]com is the hostname, and index.html is the filename. A FQDN, for example, may include the complete address of a website, computer, or other entity that may be accessed by various systems, devices, and programs. An FQDN (e.g., www[.]samplefqdn[.]com) may include a hostname (e.g., www), a second-level domain name (e.g., samplefqdn), and a top-level domain name (e.g., com). In a typical attack, a malicious actor manually or programmatically adjusts the URL of a website to make the URL to appear as the URL for the legitimate website that may have online resources of interest to a user. Such adjustments to a URL may involve a simple spelling change (e.g., CocaKola.com), font change, extension change, or a permutation or combination of numerous changes that malicious actors have at their disposal. In certain scenarios, such changes are detectable to the naked eye, however, malicious actors have begun to utilize increasingly sophisticated techniques to deceive users more readily into interacting with harmful URLs, FQDNs, or other means for accessing content. Such techniques, for example, include typosquatting and URL shortening, which are nearly impossible to detect with the naked eye.

Typosquatting is a technique utilized by malicious actors that typically involves generating a deceptive URL to appear as a legitimate URL to a user seeking to access digital resources. For example, the deceptive URL may contain a misspelling based on a typographical error, a common misspelling, a plural version of the text in the legitimate URL, adding strings to the legitimate URL, utilizing a different top-level domain, appending terms to the legitimate URL, among other types of deceptive modifications. URL shortening, on the other hand, is another technique in which a URL is made shorter than the legitimate URL by a malicious actor, but instead of directing the user to the intended digital resource redirects the user to a potentially-malicious resource. When users click on URLs made via techniques such as typosquatting or URL shortening, the users may become victims of cyberattacks. For example, when a user unwittingly clicks on a deceptive URL instead of the legitimate URL, the user may be redirected to a malicious website posing as the legitimate website. Once the user is redirected to the malicious website, the user may be deceived into providing personally-identifiable information, username and password combinations, financial information, and other private information. Malicious actors may then utilize such information to compromise user identities, take over bank accounts, apply for credit, and perform a variety of other malicious acts.

Currently, certain technologies and mechanisms exist to assist in the detection of malicious attacks, however, such technologies and mechanisms are not robust enough to thwart a sophisticated attacker. Additionally, while existing technologies provide various benefits, existing technologies often enable malicious attackers to alter URLs, FQDNs, or other mechanisms for accessing systems, content, or devices that effectively bypass such existing technologies. Furthermore, existing technologies are often constrained in their ability to adapt to changing techniques utilized by attackers. Based on at least the foregoing, technologies may be enhanced to provide enhanced suspicious URL detection capabilities, reduced ability for attackers to circumvent safeguards, and increased network and user device security, such as by using machine learning capabilities, while providing an enhanced user experience and a variety of other benefits.

### BRIEF DESCRIPTION OF THE DRAWINGS

The embodiments are illustrated by way of example and not limitation in the figures of the accompanying drawings in which like references indicate similar elements.

FIG. 1 illustrates an exemplary machine learning system for providing automated detection of suspicious digital identifiers according to embodiments of the present disclosure.

FIG. 2 illustrates an exemplary architecture to provide automated detection of suspicious digital identifiers for use with the system of FIG. 1 according to embodiments of the present disclosure.

FIG. 3 illustrates an exemplary architecture of a training pipeline service for use with the architecture of FIG. 2 according to embodiments of the present disclosure.

FIG. 4 illustrates an exemplary architecture of an inference pipeline service for use with the architecture of FIG. 2 according to embodiments of the present disclosure.

FIG. 5 illustrates an exemplary architecture of a ranker for ranking suspicious digital identifiers for use with the architecture of FIG. 2 according to embodiments of the present disclosure.

FIG. 6 illustrates an exemplary list of characters confusable with each other and may be utilized to determine whether a uniform resource locator associated with an address associated with content is suspicious according to embodiments of the present disclosure.

FIG. 7 illustrates an exemplary list of kerning confusables that may be utilized to create a canonical kerning confusables uniform resource locator copy for matching to determine a degree of suspiciousness of a uniform resource locator according to embodiments of the present disclosure.

FIG. 8 illustrates an exemplary method for providing automated detection of suspicious digital identifiers using a machine learning system according to embodiments of the present disclosure.

FIG. 9 illustrates a schematic diagram of a machine in the form of a computer system within which a set of instructions, when executed, may cause the machine to provide automated detection of suspicious digital identifiers according to embodiments of the present disclosure.

### DETAILED DESCRIPTION

The following disclosure describes various embodiments for a system 100 and accompanying methods for providing automated detection of suspicious digital identifiers (or simply identifiers) to mitigate cyberattacks and thwart malicious actors. The system 100 and methods utilize clients (e.g., phishing and content classifiers) to initiate requests to determine if digital identifiers, such as, but not limited to, addresses (e.g., web addresses), URLs, FQDNs, representations referencing web resources (e.g., visual, picture, image, perceptible, or other representations), or other mechanisms for accessing resources, that a user is attempting to access are suspicious. In certain embodiments, digital identifiers may also include resources, anything referenced by an identifier (e.g., devices, systems, programs, etc.), or a combination thereof. In certain embodiments, an identifier may be suspicious if the identifier directs a user to a web page that is malicious and/or fraudulent, the identifier is utilized to compromise a system, device, and/or program, the identifier is utilized by a malicious actor and/or system to execute a phishing attack, the identifier is utilized to compromise a network, the identifier is utilized to steal financial and/or login credentials (e.g., username and password) of a user and/or a user's contacts, the identifier is utilized to access personal or organizational information, the identifier is utilized to compromise and recruit a user device to participate in an attack (e.g., denial-of-service attack), the identifier is utilized to sign a user up for unwanted services (e.g., subscribe the user to spam or fraudulently charge and subscribe the user to services and products), the identifier is utilized to gain access to and/or control a user's device and/or devices communicatively linked to the user's device, the identifier is utilized for any other suspicious activity, or a combination thereof. In certain embodiments, the system 100 and methods may include providing the requests to an automated suspicious URL/FQDN detection system that includes an inference pipeline service and training pipeline service to facilitate the detection of suspicious digital identifiers, such as, but not limited to addresses, URLs, FQDNs, and/or other access mechanisms. In certain embodiments, the training pipeline service generates and trains machine learning models based on training data. When a request comes into the automated suspicious URL/FQDN detection system, the system 100 and methods, such as by utilizing the inference pipeline service, may include selecting a machine learning model from a model registry to perform the assessment as to whether the digital identifier is suspicious. The system 100 and methods may include computing or loading corresponding features (e.g., identifier features) associated with the digital identifier into the automated suspicious URL/FQDN detection system, and then execute the machine learning model using the identifier features to make the suspiciousness determination. In certain embodiments, the automated suspicious URL/FQDN may generate a response (e.g., an indication) indicating whether the digital identifier is suspicious and provide the response to the requesting client, such as by utilizing the inference pipeline service. In certain embodiments, if the digital identifier is determined to be suspicious, a user attempting to access a resource associated with or referenced by the digital identifier may be prevented from accessing the resource. In certain embodiments, the determination as to suspiciousness may be forwarded to experts, other systems, or a combination thereof, to verify the determination relating to the suspiciousness of the digital identifier. In certain embodiments, a suspiciousness score for the digital identifier may be generated to provide further context.

In certain embodiments, the machine learning models generated by the system 100 and methods may be trained over time, such as by utilizing the training pipeline service, to enhance the suspiciousness determination capability and other functionality of the machine learning models of the system 100. In certain embodiments, training pipeline service may receive labeled data (e.g., “class label” for a particular digital identifier (e.g., URL/FQDN)) from a database verified by an in-house security expert, researchers, and/or systems, or, in certain embodiments, may be gathered from any crowdsourced individuals, systems, or a combination thereof. In certain embodiments, the label for a digital identifier in the dataset may include a label indicating whether the digital identifier (or other data) is benign or suspicious, the suspiciousness score (e.g., degree of suspicion, which may be represented between 0 to 1 or any other scale) of the identifier, a type(s) of malicious attack associated with the digital identifier, an identity of a malicious actor and/or system associated with the digital identifier, any other labels, or a combination thereof. In certain embodiments, the training pipeline service may obtain labeled data (e.g., for a supervised machine learning technique) from the database or any such source in order to perform a training task and develop the machine learning models, which would be utilized by the inference pipeline service. In certain scenarios, it may be that not all decisions may be correct and hence, in certain embodiments, the system 100 and methods may utilize feedback from the human experts and/or other systems to verify or reject the decisions made by the system 100 and methods, such as those provided by the inference pipeline service of the system 100.

In certain embodiments, obtaining the feedback from human experts, systems, or a combination thereof, may be an automatic process. In certain embodiments, the training pipeline service may obtain the correct label of historical samples (e.g., samples of identifiers including, but not limited to, training samples, validation samples, and test samples) for which the decision may have been wrong in the past. In certain embodiments, the system 100 and methods may deploy a sampling strategy that may be configured to be utilized by the system 100 and methods to fetch new samples from the database in order to automatically retrain the system 100, and produce a new machine learning model without any human intervention in the model retraining process. In certain embodiments, the training process utilized by the training pipeline service obtaining a labeled dataset from the database and based on a suitable sampling strategy, data samples such as training samples, validation samples, and test samples may be computed from the original labeled dataset. In certain embodiments, the sampling strategy may comprise utilizing any number of training samples, validation samples, and/or test samples in the training process. In certain embodiments, the sampling strategy may include selecting only certain types of the samples for the training process. In certain embodiments, the sampling strategy may comprise utilizing only certain subsets of the samples in the labeled dataset. In certain embodiments, the sampling strategy may comprise utilizing only samples having certain types of features. In certain embodiments, the sampling strategy may be changed automatically based on time intervals, types of data present in new labeled datasets, and/or at will. In certain embodiments, the computed samples may be persisted into a sample store. Then, in certain embodiments, features (e.g., training features, such as, but not limited to, lexical, host based, image-based, content-based, and/or other features, such as those present in the labeled dataset) corresponding to each sample type may be computed and the features (e.g., training featureset, validation featureset and test featureset) may also be persisted into a feature store, such as for reusability purposes. Once features computation is completed using the system 100 and methods, a suitable supervised learning technique may be utilized to find the optimal model based on use-case-specific optimization criteria targeting selected evaluation metrics. In certain embodiments, the generated machine learning model may then be persisted in a model registry, along with useful metadata describing the machine learning model.

In certain embodiments, a system for providing automated detection of suspicious activities by utilizing machine learning is provided. In certain embodiments, the system may include a memory that stores instructions and a processor configured to execute the instructions to cause the processor to be configured to perform various operations to facilitate the detection. In certain embodiments, for example, the system may be configured to receive a request to determine whether an identifier (e.g., a web address, link, URL, FQDN, or other access or input mechanism) associated with a resource attempting to be accessed by a device associated with a user is suspicious. In certain embodiments, the resource may include, but is not limited to, a web page, content (e.g., video content, streaming content, audio content, virtual reality content, augmented reality content, haptic content, any type of content, or a combination thereof), digital documents, digital files, programs, systems, devices, any type of resource, or a combination thereof. In certain embodiments, the system may be configured to access, in response to the request, a machine learning model to facilitate determination of whether the identifier associated with the resource is suspicious. In certain embodiments, the system may be configured to load identifier features extracted from the identifier associated with the resource attempting to be accessed. In certain embodiments, the system may be configured to determine whether the identifier associated with the resource attempting to be accessed is suspicious based on execution of the machine learning model using the plurality of first features. In certain embodiments, the identifier may be configured to be determined to be suspicious if training features of the machine learning model are determined to have a similarity with the identifier features of the identifier. For example, in certain embodiments, the similarity may comprise having a direct match between the training features and the identifier features (e.g., identifier feature matches a training feature that is known to be suspicious, identified as suspicious, and/or labeled as suspicious), having a partial match (e.g., a threshold amount of matching) between the features and the identifier features, characters (e.g., numbers, punctuation, symbols, etc.) in the identifier features match characters known as suspicious (or benign) in the training features, protocols in the identifier features match protocols associated with the training features, domains of the identifier features match domains associated with the training features, strings in the identifier match strings associated with the training features, a characteristic of the identifier features matches a characteristic of the training features, the resource referenced by the identifier matches a resource associated with a training feature, any other feature matching a feature or label in the training features, or a combination thereof. In certain embodiments, the system may be configured to provide, in response to the request, an indication (or response) that the identifier is suspicious. In certain embodiments, the system may be configured to verify the indication based on feedback received relating to the indication to generate a verified indication that the address is suspicious. For example, the verified indication may confirm that the identifier is suspicious based on an assessment by a human expert, a separate machine learning system, an oracle, or a combination thereof. In certain embodiments, the system may be configured to output the verified indication and store the verified indication, which may then be incorporated into a labeled dataset to train the machine learning models of the system 100.

In certain embodiments, the system may be configured to determine a suspiciousness score for the identifier associated with the resource attempting to be accessed by the device. In certain embodiments, the system may be configured to reject the indication if the feedback received relating to the indication does not verify the indication that the identifier is suspicious, confirms that the identifier is not suspicious, or a combination thereof. In certain embodiments, the system may be configured to assign a label to the identifier indicating that the identifier is not suspicious if the indication is rejected. In certain embodiments, the system may be configured to persist the labeled identifier in a database. In certain embodiments, persisting an identifier (or other item or data of interest) may include storing an identifier (e.g., in a database, memory, etc.), keeping the identifier even after the determination and/or verification processes are conducted (or other process using the identifier is completed), maintaining the identifier in a program, system, or device, or a combination thereof. In certain embodiments, the system may be further configured to select (e.g. automatically) the machine learning model from a plurality of machine learning models to facilitate determination of whether the identifier associated with the resource is suspicious based on a type of the identifier, based on a type of the resource, based on an identity of the user, based on features extracted from the identifier, or a combination thereof. For example, information associated with the identity of the user may indicate that the user accesses or has accessed suspicious identifiers on a more frequent basis than other users, that the user typically accesses or has accessed suspicious resources (e.g., malicious websites or other content, etc.), that the user has a history of connecting to suspicious devices, systems, and/or programs, that the user has conducted suspicious activities in the past, or a combination thereof. Such information, in certain embodiments, may factor in the selection process utilized for selecting a machine learning model, determining whether an identifier is suspicious, or a combination thereof. In certain embodiments, the system may be configured to sample at least one labeled dataset from a database in accordance with a sampling strategy. In certain embodiments, the system may be configured to compute at least one training sample (e.g., a sample utilized to facilitate training and/or creation of a machine learning model), at least one validation sample (e.g., a sample for use in a process to evaluate a developed or updated machine learning model with a testing dataset), at least one test sample (e.g., a sample for testing a machine learning model's performance in achieving the desired functionality), or a combination thereof, from the at least one labeled data set. In certain embodiments, the system may be further configured to persist the at least one training sample, the at least one validation sample, the at least one test sample, or a combination thereof, in a sample store. In certain embodiments, a portion of the samples sampled from a labeled data set may be dedicated for training, a portion of the samples may be dedicated for validation, and a portion of the samples may be dedicated for testing. In certain embodiments, the training samples and the training features of the training samples may be utilized to train the machine learning models of the system 100. In certain embodiments, the machine learning models may be trained with samples that are known, identifier, or labeled as suspicious and with samples that are known, identified, or labeled as not suspicious (or harmless or benign). In certain embodiments, based on features that are labeled, known, or identified as being suspicious that are included in the training samples, the machine learning models may be trained to determine that an identifier, having identifier features having a similarity with the training features that are labeled, known, or identified as being suspicious, are suspicious.

In certain embodiments, the system may be further configured to compute at least a portion of the identifier features (e.g., a subset of the features) based on the at least one training sample, the at least one validation sample, the at least one test sample, or a combination thereof. In certain embodiments, a remaining portion of the identifier features may have already been computed or may already exist in the system 100, such as in a feature store. In certain embodiments, a portion of the identifier features may be a subset of the identifier features that may include one or more identifier features. In certain embodiments, the system may be further configured to utilize a supervised learning technique to build or develop the machine learning model and update the machine learning model based on the portion of the identifier features, case-specific optimization criteria targeting a selected evaluation metric, or a combination thereof. In certain embodiments, the system may be further configured to generate metadata describing one or more characteristics of the machine learning model. In certain embodiments, the system may be configured to persist the machine learning model and the metadata in a model registry. In certain embodiments, the identifier features may include, but are not limited to, a lexical feature (e.g., word length, frequency, language, density, complexity, formality, any feature that distinguishes a malicious identifier from a benign identifier, other lexical feature, or a combination thereof), a host-based feature (e.g., host feature as described in the present disclosure), a webpage screenshot feature (e.g., an image of a resource that the identifier references), a word character feature (e.g., symbols, letters, punctuation and/or other characters in the identifier), a number feature (e.g., numbers present in the identifier), a protocol feature (e.g., a protocol associated with the identifier), a domain feature (e.g., a type of the domain, the specific domain present in the identifier, and/or the characters present in the domain), another type of feature, or a combination thereof. In certain embodiments, the system may be configured to train the machine learning model based on a verification of the indication. In certain embodiments, the verification of the indication may be based on feedback associated with the indication that confirms whether the identifier is suspicious. In certain embodiments, the system may be further configured to rank the identifier relative to a plurality of other ranked identifiers based on a suspiciousness score calculated for the identifier and the plurality of other ranked identifiers.

In certain embodiments, a method for providing automated detection of suspicious identifiers if provided. In certain embodiments, the method may be configured to be performed by a processor executing instructions from a memory of a device. In certain embodiments, the method may include receiving a request to determine whether an identifier associated with resource attempting to be accessed by a device associated with a user is suspicious. In certain embodiments, the method may include selecting, in response to the request, a machine learning model to facilitate determination of whether the identifier associated with the content is suspicious. In certain embodiments, the method may include loading identifier features extracted from the identifier associated with the resource attempting to be accessed. In certain embodiments, the method may include determining whether the identifier associated with the resource attempting to be accessed is suspicious based on execution of the machine learning model using the identifier features. In certain embodiments, the identifier may be determined to be suspicious if training features of the machine learning model are determined to have a similarity with the identifier features. In certain embodiments, the method may include providing, in response to the request, an indication that the identifier is suspicious. In certain embodiments, the method may include confirming performance of the machine learning model based on feedback on feedback verifying the indication, an accuracy of the indication, a speed of the machine learning model in determining whether the identifier is suspicious, an uptime of the machine learning model, a latency of the machine learning model, or a combination thereof.

In certain embodiments, the method may include outputting an alert to the device associated with the user indicating that the identifier is suspicious. In certain embodiments, the method may include enabling the device associated with the user to access the resource via the identifier if the identifier is determined to not be suspicious. In certain embodiments, the method may include redirecting the device of the user to a different resource if the identifier associated with the resource is determined to be suspicious. In certain embodiments, the method may include verifying that the indication that the identifier is suspicious is accurate. In certain embodiments, the method may include storing a labeled dataset based on the verifying that the indication that the identifier is suspicious is accurate. In certain embodiments, the method may include updating and/or training the machine learning model(s) based on the labeled dataset. In certain embodiments, the method may include comparing characters of the identifier to a list of confusable characters or other kinds of lexical characters. In certain embodiments, the method may include determining that the identifier is suspicious if one or more characters of the characters of the address match a type of character in a list of confusable characters (or other lexical characters) not expected to be in the identifier. In certain embodiments, the method may include determining whether a character in the identifier matches a type of character not expected to be in the identifier. In certain embodiments, the method may include generating, if the character matches the type of character not expected to be in the identifier, a copy of the identifier by replacing the character with an expected character. In certain embodiments, the method may include comparing the copy of the identifier to a list of authoritative strings. In certain embodiments, the method may include raising a suspiciousness score or degree of suspiciousness associated with the identifier if the copy of the identifier matches a string in the list of authoritative strings.

In certain embodiments, a non-transitory computer readable medium comprising instructions, which, when loaded and executed by a processor, cause the processor to be configured to perform a plurality of operations. In certain embodiments, the processor may be configured to receive a request to determine whether an identifier for accessing a resource is suspicious. In certain embodiments, the processor may be configured to select, in response to the request, a machine learning model to facilitate determination of whether the identifier for accessing the resource is suspicious. In certain embodiments, the processor may be configured to load identifier features extracted from the identifier for accessing the resource. In certain embodiments, the processor may be configured to determine whether the identifier for accessing the resource is suspicious based on execution of the machine learning model using the identifier features. In certain embodiments, the identifier may be determined to be suspicious if training features of the machine learning model are determined to have a similarity with the identifier features. In certain embodiments, the processor may be configured to provide, if the identifier features of the identifier are determined to have the similarity with the training features, an indication that the identifier is suspicious. In certain embodiments, the processor may be further configured to prevent accessing of the identifier, the resource, or a combination thereof, based on the indication that the identifier is suspicious.

In certain embodiments, another system for providing automated detection of suspicious identifiers is provided. In certain embodiments, the system may include a memory that stores instructions and a processor that is configured to execute the instructions to cause the processor to be configured to perform a variety of operations. In certain embodiments, the system may be configured to obtain labeled datasets that comprise data verified as suspicious or not suspicious, extract training features from the labeled datasets (e.g., extracted from samples of the labeled datasets), and train machine learning models using the training features extracted from the labeled datasets. In certain embodiments, the system may be configured to receive a request to determine whether an identifier associated with a resource attempting to be accessed by a device associated with a user is suspicious. In certain embodiments, the system may be configured to access, in response to the request, at least one machine learning model to facilitate determination of whether the identifier associated with the resource is suspicious. In certain embodiments, the system may be configured to load identifier features extracted from the identifier associated with the resource attempting to be accessed. In certain embodiments, the system may be configured to determine whether the identifier associated with the resource attempting to be accessed is suspicious based on execution of the machine learning model using the identifier features. In certain embodiments, the identifier may be determined to be suspicious if training features of the machine learning model have a similarity to identifier features of the identifier. In certain embodiments, the system may be configured to provide, in response to the request, an indication that the identifier is suspicious.

Based on at least the foregoing, the systems and methods provided in the present disclosure may be utilized to detect suspicious types of identifiers, such as, but not limited to, addresses (e.g., web addresses), URLs, FQDNs, and/or other access mechanisms for accessing content, applications, and/or systems. Additionally, the systems and methods may incorporate expert and/or system feedback to rectify potential misjudgments of suspiciousness or lack of suspiciousness by the systems. In certain embodiments, the systems and methods may be utilized to automatically retrain a machine learning system to avoid problems, such as, but not limited to, concept drift. In certain embodiments, the systems and methods may incorporate different features during detection of suspiciousness of the identifier, such as an address, URL, FQDN, and/or other access mechanism. In certain embodiments, the systems and methods may be configured to automatically select the optimal machine learning model during the model training process and/or at other times. In certain embodiments, the system and methods may be configured to sample labeled data to avoid or reduce problems associated with imbalanced data. In certain embodiments, the systems and methods may utilize any types of machine learning or artificial intelligence algorithms to support the functionality provided by the present disclosure. In certain embodiments, the system and methods may significantly enhance the user's experience as it relates to interacting with identifiers to obtain access to various types of resources of interest. The system and methods may be configured to operate such that determinations of whether an identifier is suspicious are done in real-time to ensure that the user has a smooth and uninterrupted experience while interacting with identifiers. The system and methods may also be configured to provide suspiciousness detections and access (or prevention of access to) to resources associated with identifiers significantly faster than existing technologies, while also having greater performance (e.g., lower use of computer resources, enhanced determinations over time as the machine learning models are trained with labeled datasets, enhanced security, among other performance enhancements).

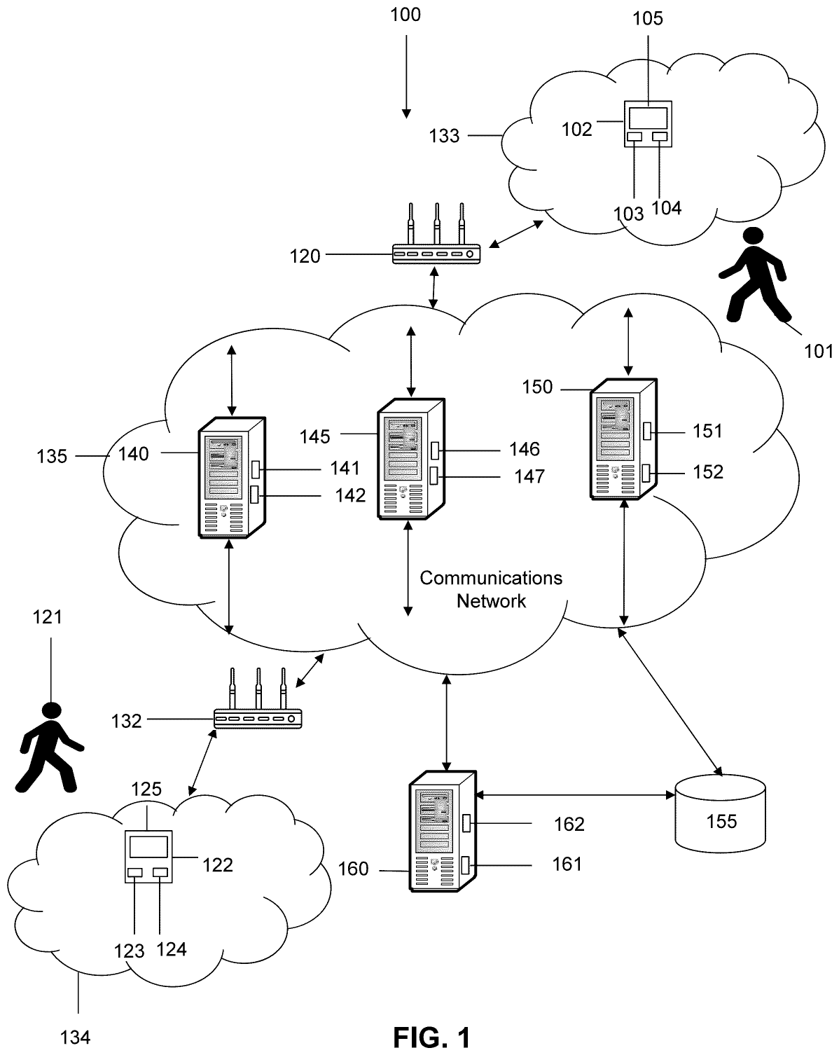

As shown in FIGS. 1-7, a system 100 for providing automated detection of suspicious identifiers (e.g., digital identifiers) utilizing machine learning is provided. Notably, the system 100 may be configured to support, but is not limited to supporting, cybersecurity systems and services, monitoring and surveillance systems and services, phishing and content protection classification systems and services, ranking systems and services, SASE systems and services, cloud computing systems and services, privacy systems and services, firewall systems and services, data analytics systems and services, data collation and processing systems and services, artificial intelligence services and systems, machine learning services and systems, neural network services, autonomous vehicle applications and services, mobile applications and services, alert systems and services, content delivery services, satellite services, telephone services, voice-over-internet protocol services (VoIP), software as a service (SaaS) applications, platform as a service (PaaS) applications, gaming applications and services, social media applications and services, operations management applications and services, productivity applications and services, and/or any other computing applications and services. Notably, the system 100 may include a first user 101, who may utilize a first user device 102 to access data, content, and services, or to perform a variety of other tasks and functions. As an example, the first user 101 may utilize first user device 102 to transmit signals to access various online services and content, such as those available on an internet, on other devices, and/or on various computing systems. In certain embodiments, the first user 101 may utilize the first user device 102 to access services, applications, and/or content, such as by interacting with uniform resource locators (URLs), fully qualified domain names (FQDNs), links, and/or other mechanisms for accessing services, applications, and/or content. As another example, the first user device 102 may be utilized to access an application, devices, and/or components of the system 100 that provide any or all of the operative functions of the system 100.

In certain embodiments, the first user 101 may be a person, a robot, a humanoid, a program, a computer, any type of user, or a combination thereof, that may be located in a particular location or environment. In certain embodiments, the first user 101 may be a person that may want to utilize the first user device 102 to conduct various types of activities and/or access content. For example, an activity may include, but is not limited to, accessing digital resources, such as, but not limited to, website content, application content, video content, audio content, haptic content, audiovisual content, virtual reality content, augmented reality content, any type of content, or a combination thereof. In certain embodiments, other activities may include, but are not limited to, accessing various types of applications, such as to perform work, create content, experience content, communicate with other users, transmit content, upload content, download content, or a combination thereof. In certain embodiments, other activities may include interacting with links for accessing and/or interacting with devices, systems, programs, or a combination thereof.

In certain embodiments, the first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102 and to interact with the system 100. In certain embodiments, the first user device 102 may be and/or may include a computer, any type of sensor, a laptop, a set-top-box, a tablet device, a phablet, a server, a mobile device, a smartphone, a smart watch, a voice-controlled-personal assistant, a physical security monitoring device (e.g., camera, glass-break detector, motion sensor, etc.), an internet of things device (IoT), appliances, an autonomous vehicle, and/or any other type of computing device. Illustratively, the first user device 102 is shown as a computer in FIG. 1. In certain embodiments, the first user device 102 may be utilized by the first user 101 to control, access, and/or provide some or all of the operative functionality of the system 100.

In addition to using first user device 102, the first user 101 may also utilize and/or have access to any number of additional user devices. As with first user device 102, the first user 101 may utilize the additional user devices to transmit signals to access various online services and content and/or access functionality provided by an enterprise. The additional user devices may include memories that include instructions, and processors that executes the instructions from the memories to perform the various operations that are performed by the additional user devices. In certain embodiments, the processors of the additional user devices may be hardware, software, or a combination thereof. The additional user devices may also include interfaces that may enable the first user 101 to interact with various applications executing on the additional user devices and to interact with the system 100. In certain embodiments, the first user device 102 and/or the additional user devices may be and/or may include a computer, any type of sensor, a laptop, a set-top-box, a tablet device, a phablet, a server, a mobile device, a smartphone, a smart watch, an autonomous vehicle, and/or any other type of computing device, and/or any combination thereof. Sensors may include, but are not limited to, cameras, motion sensors, acoustic/audio sensors, pressure sensors, temperature sensors, light sensors, any type of sensors, or a combination thereof.

The first user device 102 and/or additional user devices may belong to and/or form a communications network 133. In certain embodiments, the communications network 133 may be a local, mesh, and/or other network that enables and/or facilitates various aspects of the functionality of the system 100. In certain embodiments, the communications network may be formed between the first user device 102 and additional user devices through the use of any type of wireless or other protocol and/or technology. For example, user devices may communicate with one another in the communications network by utilizing any protocol and/or wireless technology, satellite, fiber, or any combination thereof. Notably, the communications network may be configured to communicatively link with and/or communicate with any other network of the system 100 (e.g., communications network 135) and/or outside the system 100.

In certain embodiments, the first user device 102 and additional user devices belonging to the communications network 133 may share and exchange data with each other via the communications network 133. For example, the user devices may share information relating to the various components of the user devices, information associated with images, links, and/or content accessed and/or attempting to be accessed by the first user 101 of the user devices, information identifying the locations of the user devices, information indicating the types of sensors that are contained in and/or on the user devices, information identifying the applications being utilized on the user devices, information identifying how the user devices are being utilized by a user, information identifying user profiles for users of the user devices, information identifying device profiles for the user devices, information identifying the number of devices in the communications network 133, information identifying devices being added to or removed from the communications network 133, any other information, or any combination thereof.

In certain embodiments, the system 100 may include an edge device 120, which the first user 101 may access to gain access to various resources, devices, systems, programs, or a combination thereof, outside the communications network 133. In certain embodiments, the edge device 120 may be or may include, network servers, routers, gateways, switches, media distribution hubs, signal transfer points, service control points, service switching points, firewalls, routers, nodes, computers, proxy device, mobile devices, or any other suitable computing device, or any combination thereof. In certain embodiments, the edge device 120 may connect with any of the devices and/or componentry of the communications network 135. In certain embodiments, the edge device 120 may be provided by and/or be under the control of a service provider, such as an internet, television, telephone, and/or other service provider of the first user 101. In certain embodiments, the edge device 120 may be provided by and/or be under control of an enterprise. In certain embodiments, the system 100 may operate without the edge device 120 and the first user device 102 may operate as an edge device, such as for communications network 135.

In addition to the first user 101, the system 100 may also include a second user 121. In certain embodiments, the second user 121 may be similar to the first user 101 and may seek to access content, applications, systems, and/or devices, such as by interacting with an identifier, such as, but not limited to, a web address, a link, a URL, a FQDN, and/or other interactable mechanism capable of connecting the second user 121 with content, applications, systems, and/or devices. In certain embodiments, the second user device 122 may be utilized by the second user 121 to transmit signals to request various types of resources, content, services, and data provided by and/or accessible by communications network 135 or any other network in the system 100. In further embodiments, the second user 121 may be a robot, a computer, a vehicle (e.g. semi or fully-automated vehicle), a humanoid, an animal, any type of user, or any combination thereof. In certain embodiments, the second user 121 may be an expert who may verify or reject suspiciousness determinations made by the automated suspicious URL/FQDN detection system 206. In certain embodiments, the second user 121 may be a hacker or malicious actor attempting to compromise the first user 101 or other users and/or devices. The second user device 122 may include a memory 123 that includes instructions, and a processor 124 that executes the instructions from the memory 123 to perform the various operations that are performed by the second user device 122. In certain embodiments, the processor 124 may be hardware, software, or a combination thereof. The second user device 122 may also include an interface 125 (e.g. screen, monitor, graphical user interface, etc.) that may enable the first user 101 to interact with various applications executing on the second user device 122 and, in certain embodiments, to interact with the system 100. In certain embodiments, the second user device 122 maybe a computer, a laptop, a set-top-box, a tablet device, a phablet, a server, a mobile device, a smartphone, a smart watch, an autonomous vehicle, and/or any other type of computing device. Illustratively, the second user device 122 is shown as a mobile device in FIG. 1. In certain embodiments, the second user device 122 may also include sensors, such as, but are not limited to, cameras, audio sensors, motion sensors, pressure sensors, temperature sensors, light sensors, humidity sensors, any type of sensors, or a combination thereof. In certain embodiments, the second user 121 may also utilize additional user devices as well.

In certain embodiments, the second user device 122 and additional user devices belonging to the communications network 134 may share and exchange data with each other via the communications network 134. For example, the user devices may share information relating to the various components of the user devices, information associated with images, links, and/or content accessed and/or attempting to be accessed by the second user 121 of the user devices, information identifying the locations of the user devices, information indicating the types of sensors that are contained in and/or on the user devices, information identifying the applications being utilized on the user devices, information identifying how the user devices are being utilized by a user, information identifying user profiles for users of the user devices, information identifying device profiles for the user devices, information identifying the number of devices in the communications network 134, information identifying devices being added to or removed from the communications network 134, any other information, or any combination thereof. In certain embodiments, the system 100 may include edge device 132, which may be utilized by the second user device 122 and/or additional user devices to communicate with other networks, such as communications network 135, and/or devices, programs, and/or systems that are external to the communications network 134, such as communications network 133.

In certain embodiments, the user devices described herein may have any number of software functions, applications and/or application services stored and/or accessible thereon. For example, the user devices may include applications for controlling and/or accessing the operative features and functionality of the system 100, applications for controlling and/or accessing any device of the system 100, artificial intelligence and/or machine learning applications, cybersecurity applications, interactive social media applications, biometric applications, cloud-based applications, VoIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications may support the functionality provided by the system 100 and methods described in the present disclosure. In certain embodiments, the software applications and services may include one or more graphical user interfaces so as to enable the first and/or second users 101, 121 to readily interact with the software applications. The software applications and services may also be utilized by the first and/or second users 101, 121 to interact with any device in the system 100, any network in the system 100, or any combination thereof. In certain embodiments, user devices may include associated telephone numbers, device identities, network identifiers (e.g., IP addresses, etc.), and/or any other identifiers to uniquely identify the user devices.

The system 100 may also include a communications network 135. The communications network 135 may include resources (e.g., data, web pages, content, documents, computing resources, applications, and/or any other resources) that may be accessible to the first user 101 and/or second user 121. The communications network 135 of the system 100 may be configured to link any number of the devices in the system 100 to one another. For example, the communications network 135 may be utilized by the second user device 122 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a neural network, a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region, or be part of multiple autonomous systems that span several geographic regions.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, any network, any device in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or may be connected to a processor and memory to perform the various operations associated with the database 155. In certain embodiments, the database 155 may be connected to the servers 140, 145, 150, 160, the first user device 102, a second user device 122, the communications network 133, the communications network 134, the communications network 135, a server 140, a server 145, a server 150, a server 160, edge devices 120, 132, and a database 155, the additional user devices, any devices in the system 100, any process of the system 100, any program of the system 100, any other device, any network, or any combination thereof.

The database 155 may also store information and metadata obtained from the system 100, store metadata and other information associated with the first and second users 101, 121, store profiles for the networks of the system, store telemetry data, indications that indicate whether an identifier, such as, but not limited to, a link, URL, FQDN, and/or other interactable mechanism is suspicious or not, information identifying the networks of the system 100, store suspiciousness scores determined for identifiers, such as, but not limited to, links, URLs, FQDNs, and/or other interactable mechanisms, store machine learning models, store training data and/or information utilized to train the machine learning models (e.g., labeled datasets, training samples, validation samples, testing samples, etc.), store algorithms supporting the functionality of the machine learning models, store verifications of indications that an identifier, such as, but not limited to, a link, URL, FQDN, and/or interactable mechanism is suspicious or not, store alerts outputted by the system 100, store features utilized by the machine learning models to make determinations, store data shared by devices in the networks, store configuration information for the networks and/or devices of the system 100, store user profiles associated with the first and second users 101, 121, store device profiles associated with any device in the system 100, store communications traversing the system 100, store user preferences, store information associated with any device or signal in the system 100, store information relating to patterns of usage relating to the user devices, store any information obtained from any of the networks in the system 100, store historical data associated with the first and second users 101, 121, store device characteristics, store information relating to any devices associated with the first and second users 101, 121, store information associated with the communications network 135, store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, receiving requests to determine whether an identifier, such as, but not limited to, an address, link, URL, FQDN and/or other interactable mechanism for accessing resources is suspicious or not; accessing and/or obtaining machine learning models to determine whether the identifier, such as an address, link, URL, FQDN, and/or other interactable mechanism is suspicious; loading features (e.g., identifier features) extracted from or are associated with the identifier, such as an address, link, and/or other interactable mechanism; determining whether the identifier, such as an address, link, URL, FQDN, and/or other interactable mechanism is suspicious based on execution of the machine learning model using the features; providing an indication that the identifier, such as address, link, URL, FQDN, and/or other interactable mechanism is suspicious; verifying that the indication based on feedback relating to the indication to generate a verified indication that the identifier is suspicious; outputting the verified indication; training models based on the verified indication; preventing access to the resources for which the indication indicates that the identifier, such as an address, link, URL, FQDN, and/or other interactable mechanism is suspicious; and/or performing any other operations of the system 100; and performing any other suitable operations conducted in the system 100 or otherwise. In certain embodiments, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

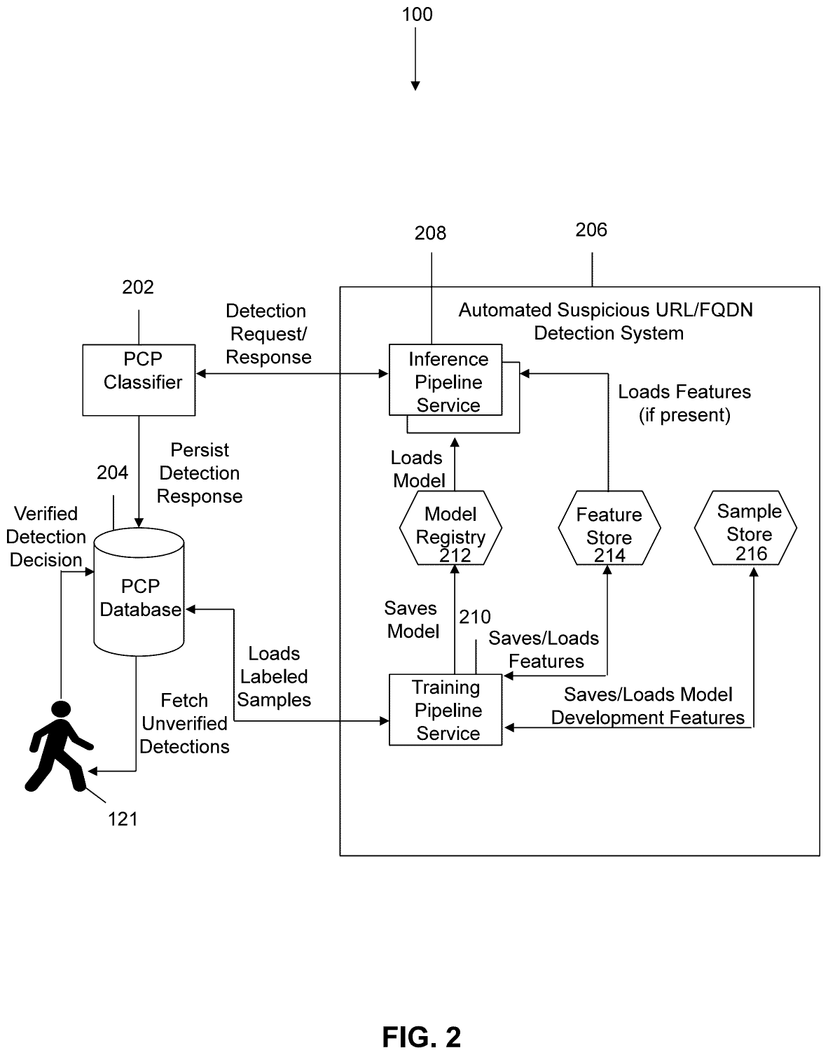

Referring now also to FIG. 2, an exemplary architecture to provide automated detection of suspicious identifiers for use with the system 100 of FIG. 1 according to embodiments of the present disclosure is shown. In certain embodiments, the system 100 may include a phishing and content protection (PCP) classifier 202, a PCP database 204 (e.g. may correlate with database 155), an automated suspicious URL/FQDN detection system 206, or a combination thereof. In certain embodiments, the automated suspicious URL/FQDN detection system 206 may include a plurality of componentry and functionality. For example, in certain embodiments, the automated suspicious URL/FQDN detection system 206 may include an inference pipeline service 208 (which may be configured to process any number of requests in parallel or in other sequences), a training pipeline service 210, a model registry 212, a feature store 214, a sample store 216, and/or any other componentry. In certain embodiments, the componentry of the architecture may comprise hardware, software, or a combination of hardware and software. The functionality provided via the architecture may be performed by utilizing memories and/or processors.

In certain embodiments, the PCP classifier 202 may comprise software, hardware, or a combination of hardware and software. In certain embodiments, the PCP classifier 202 may be configured to serve as a client with respect to the automated suspicious URL/FQDN detection system 206. In certain embodiments, the PCP classifier 202 may be configured to analyze all requests being made by devices, systems, programs, or a combination thereof, being monitored by the PCP classifier 202. In certain embodiments, the PCP classifier 202 may be configured to analyze any requests (e.g., web requests, requests to access online resources, requests to access computing systems, requests to access devices, and/or other requests) before a device, system, and/or program is able to access the content, information, devices, systems, or a combination thereof, that the requests are seeking to access. In certain embodiments, the PCP classifier 202 may be configured to make a preliminary determination regarding the suspiciousness of an identifier (e.g., URL, FQDN, web address, link, or other access mechanism) based on comparing the identifier to a list of identifiers known to be suspicious or not suspicious. In certain embodiments, the PCP classifier 202 may be configured to forward each request directly to the automated suspicious URL/FQDN detection system 206 without making a preliminary determination first so that the automated suspicious URL/FQDN detection system 206 may make the determination regarding suspiciousness of the request and identifier associated with the request. In certain embodiments, the PCP classifier 202 may be configured to classify and/or label requests and/or identifiers as being suspicious based on the determinations (or indications) from the automated suspicious URL/FQDN detection system 206 and persist (or store) the classifications and/or labels in a PCP database 204, which may be database 155 or a different database.

In certain embodiments, the labeled dataset may be utilized by the automated suspicious URL/FQDN detection system 206 to train machine learning models for subsequent determinations relating to suspiciousness. In certain embodiments, the determinations (or indications) from the PCP database 204 may be submitted for further verification, such as by a user 121 and/or by any other componentry of the system 100. If the user 121 or other componentry verifies the determination, the verified determination of suspiciousness may be stored in the PCP database 204 and may then be utilized by the PCP classifier 202 to prevent a device from accessing a resource associated with the identifier (e.g., web address, link, URL, FQDN, or other access mechanism) based on the verified determination of suspiciousness. If the user 121 or other componentry rejects the original determination (or indication), the rejection may be saved in the PCP database 204 and the device may be authorized to interact with the identifier and access the resource that the identifier is directed to.

In certain embodiments, the inference pipeline service 208 may be configured to obtain and/or access machine learning models from the model registry 212, which may be generated and/or trained by the training pipeline service 210. In certain embodiments, the inference pipeline service 208 may receive requests from the PCP classifier 202, which may be configured to detect when a user (e.g., first user 101) of user device (e.g., first user device 102) is attempting to access an identifier (e.g., URL, address, FQDN, access mechanism, and/or link). Upon detection of the access attempt, the PCP classifier 202 may generate a request for the automated suspicious URL/FQDN detection system 206 to determine whether the identifier (e.g., URL) and/or resource referenced by the identifier is suspicious. In certain embodiments, the request may be received by the inference pipeline service 208 of the automated suspicious URL/FQDN detection system 206. Once the request is received, the inference pipeline service 208 may select a machine learning model (e.g., an optimal machine learning model) to process the request to make the determination regarding suspiciousness of the identifier and/or the resource(s) relating thereto. In certain embodiments, the machine learning model may be selected from the model registry 212. In certain embodiments, the machine learning models may be developed and/or trained by the training pipeline service 210, which may persist developed and trained machine learning models in the model registry 212.

In certain embodiments, once a machine learning model is obtained from the model registry 212, such as in response to receipt of a request from the PCP classifier 202, the inference pipeline service 208 may also load the corresponding features from a feature store 214. In certain embodiments, the features that represent an identifier, such as, but not limited to, an address, URL, FQDN, and/or other access mechanism could be of any categories such as lexical, host based, webpage screenshot based, content-based, and/or other categories, which are described herein. The inference pipeline service 208 may be configured to load any of such features from the feature store 214 if the corresponding feature exists, or the inference pipeline service 208 may dynamically compute such features directly from the identifier (e.g., web address, URL, FQDN, or other access mechanism) in question and/or from samples having a correlation to the identifier that may be obtained from the sample store 216 and which may have been originally obtained from the PCP database 204.

In certain embodiments, the inference pipeline service 208 may then be configured to determine whether the particular identifier (e.g., address, URL, FQDN, or other access mechanism) is suspicious or not based on the retrieved model and relevant features. In certain embodiments, the determination may be made by executing the machine learning model using the relevant features. For example, if identifier features of the identifier have a similarity (e.g., a threshold similarity) with training features that the machine learning model has been trained to identify as suspicious, the identifier may be determined to be suspicious. As another example, if certain identifier features have characteristics in common with training features known to be suspicious, such commonality may be utilized to determine that the identifier is suspicious. In certain embodiments, apart from deciding the class label such as suspicious or benign for the identifier (e.g., address, URL, FQDN, or other access mechanism), the inference pipeline service 208 may optionally determine the suspiciousness score of the requested identifier (e.g., address, URL, FQDN, or other access mechanism). For example, the scores may range from 0 to 1 or from 0-100 and the higher the score, the higher the suspiciousness of the identifier. In certain embodiments, for example, the score may be based on the type of risk associated with the identifier (e.g., redirects to mostly harmless advertisements vs. redirecting to a malicious website that is utilized by malicious actors to steal credit card numbers and social security numbers). Once the decision is made about the requested identifier (e.g., address, URL, FQDN, or other access mechanism), the inference pipeline service 208 may provide the determination and/or score in a response back to the PCP classifier 202 in response to the PCP classifier's 202 request. After obtaining the decision about an identifier (e.g., address, URL, FQDN, or other access mechanism), the PCP classifier 202 can persist that information into the PCP database 204.

In certain embodiments, the training pipeline service 210 may be utilized to train and/or develop machine learning models that may be utilized by the inference pipeline service 208 to make suspiciousness determinations. For example, in certain embodiments, the training pipeline service 210 may be configured to receive labeled data (i.e. “class label” which is known for a particular URL/FQDN) from the PCP database 204 verified by in-house security experts or researchers (e.g., second user 121), or the data may be gathered from any crowdsourced people, devices, and/or systems that may be external to the system 100. In certain embodiments, the training pipeline service 208 may obtain labeled data (such as for a supervised machine learning technique) from the PCP database 204 or any such source in order to perform the training task and develop a machine learning model that may be consumed and/or executed by the inference pipeline service 208. In certain scenarios, it may be that not all decisions made by the system 100 may be correct an, as a result, the system 100 may verify such decisions using feedback from a human expert, other systems, devices, and/or artificial intelligence systems about the decisions made by the system 100, and particularly the inference pipeline service 208 of the system 100.

In certain embodiments, the obtaining of the feedback from human experts (or other devices and systems) may be an automatic process, and the training pipeline service 210 can obtain the correct label of historical samples from labeled datasets for which the decision was wrong in the past, such as from the PCP database 204. In certain embodiments, a sampling strategy may be utilized to fetch new samples from the PCP database 204 in order to automatically retrain the system 100 and/or machine learning models, and produce a new machine learning model without any human intervention in the model retraining process. In certain embodiments, the training process inside the training pipeline service 210 may include a plurality of steps. For example, initially, the labeled dataset (which may include previous determinations and/or labeled samples that have been fed into the PCP database 204) may be to be obtained from the PCP database 204, and, based on a selected or random sampling strategy, data samples such as training samples, validation samples and test samples may be computed from the original labeled dataset. In certain embodiments, the computed samples may be persisted into a sample store 216.

Then, in certain embodiments, features (e.g., lexical, host based, content-based, etc.) corresponding to each sample type may be computed and the features (e.g., training featureset, validation featureset and test featureset) may also be persisted into a feature store 214, such as for reusability purposes. Once features computation is completed, one or more supervised learning techniques may be utilized to find the optimal model based on use case specific optimization criteria targeting certain evaluation metrics. Such criteria and/or metrics may relate to the required amount of computer resources that may be used by a model, whether the model is capable of making a determination relating to suspiciousness, whether the model is of a certain size, whether the model has certain functionality, whether the model has a particular machine learning and/or artificial intelligence algorithm, whether the model is capable of provide higher accuracy determinations (e.g., a threshold level), whether the model is more efficient than other models, and/or any other criteria and/or evaluation metrics. In certain embodiments, the developed machine learning model may be persisted in a model registry 212 along with useful metadata about the model. In certain embodiments, the metadata may be utilized to describe the features and/or functionality of the model, the types of algorithms that the model utilizes, the types of determinations that the model is capable of making, the types of features that the model may process, the types of training data utilized to train the model, the datasets utilized to train the model, a version of the model, a last update time of the model, any other information associated with the model, or a combination thereof. Exemplary algorithms that may be utilized by the system 100 may include, but are not limited to, classification algorithms, logistic regression algorithms, support vector machine algorithms, Naïve Bayes algorithms, decision trees, ensemble techniques, deep learning algorithms, and/or any other types of algorithms.

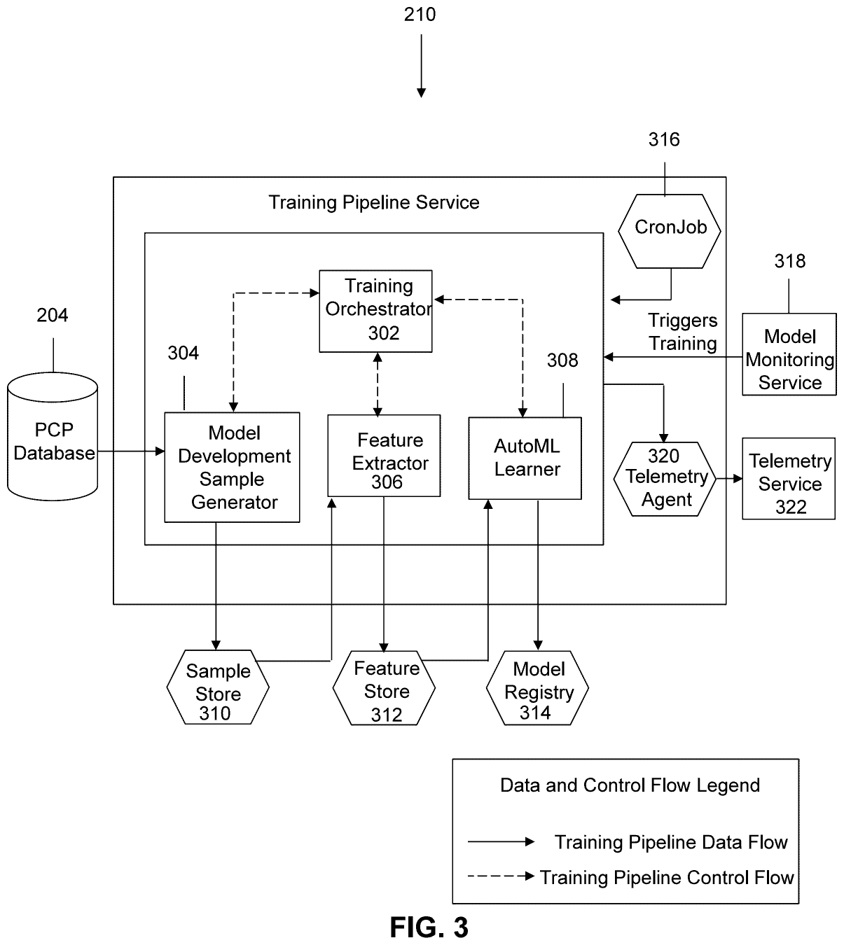

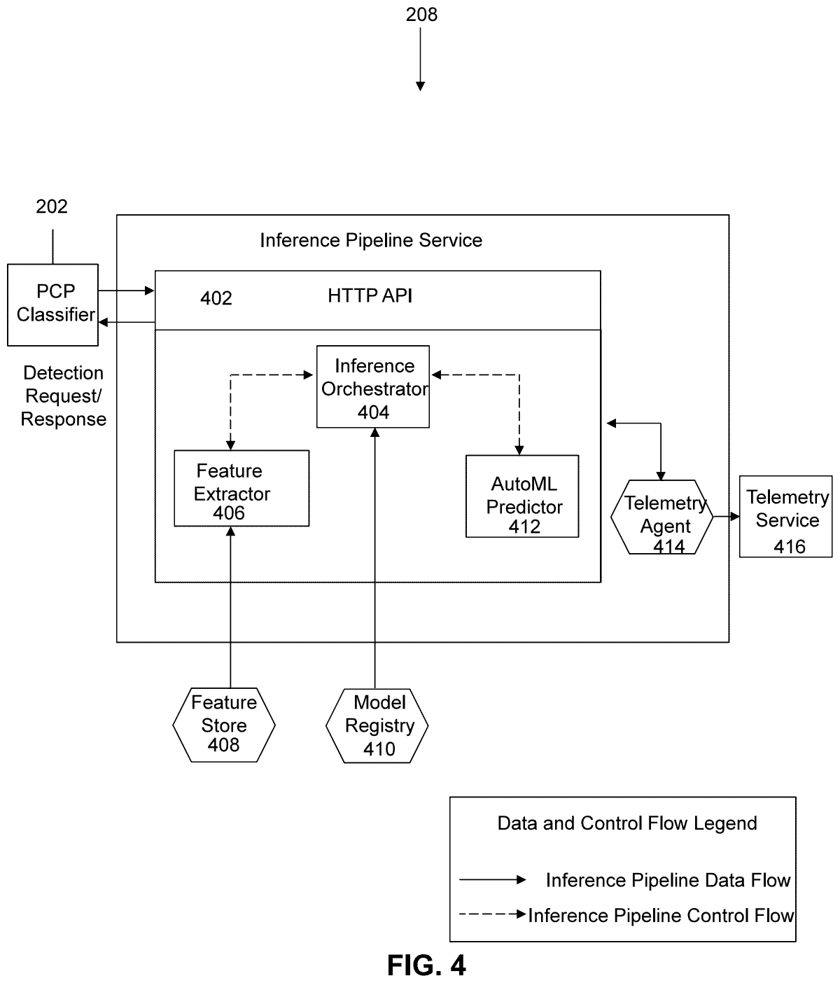

Referring now also to FIGS. 3 and 4, further details relating to exemplary architectures and functionality of the training pipeline service 210 and the inference pipeline service 208 are shown. In certain embodiments, the dashed lines in FIGS. 3-4 may represent control signal flow and the solid lines may represent data flow. In FIG. 3, exemplary componentry of the training pipeline service 210 is shown. In certain embodiments the training pipeline service 210 may be communicatively linked to the PCP database 204, such as to receive labeled datasets (e.g., including data labeled indicating suspicious or not) which may be utilized to train and/or develop models for use by the inference pipeline service 208 to determine suspiciousness of address, URLs, FQDNs, and/or other access mechanisms that a user may be attempting to access to gain access to various online or other resources. In certain embodiments, the training pipeline service 210 may include, but is not limited to including, a training orchestrator 302, a model development sample generator 304, a feature extractor 306, a learner 308 (e.g., an AutoML learner), a sample store 310 (may be the same as sample store 216), a feature store 312 (may be the same as feature store 214), a model registry 314 (may be the same as model registry 212), a CronJob 316, a model monitoring service 318, a telemetry agent 320, a telemetry service 322, any other componentry, or a combination thereof.

In certain embodiments, when developing and/or training a machine learning model, the training pipeline service 210 may be configured to obtain labeled datasets from the PCP database 204, which may have received the labeled datasets from the PCP classifier 202 during operation of the system 100. In certain embodiments, the training orchestrator 302 may transmit a signal activating operation of the model development sample generator 304. In certain embodiments, the model development sample generator 304 may be configured to receive labeled datasets from the PCP database 204 and then generate a plurality of samples from the labeled datasets. For example, in certain embodiments, the model development sample generator 304 may be configured to utilize a sampling strategy to compute data samples from the labeled datasets. In certain embodiments, the data samples may include, but are not limited to, training samples (e.g., samples to train models), validation samples (e.g., samples relating to validation of a determination of suspiciousness and/or samples for use in a process to evaluate a developed or updated machine learning model with a testing dataset), and test samples (e.g., samples to test functionality of the machine learning models). In certain embodiments, the generated samples may be stored in the sample store 310 for use by other componentry of the system 100. In certain embodiments, the model development sample generator 304 may notify the training orchestrator 302 of the generation of the samples from the labeled dataset.

In certain embodiments, the training orchestrator 302 may be configured to transmit a control signal to the feature extractor 306, which may be configured to obtain the samples from the sample store 310. In certain embodiments, the feature extractor 306 may be configured to extract features (e.g., training features, such as, but not limited to, lexical, host-based, content-based, etc.) from the samples provided by the sample store 310. Once the features are extracted, the feature extractor 306 may store the features in feature store 312 so that they may be utilized by various components of the system 100. The feature extractor 306 may notify the training orchestrator 302 that the features have been extracted from the samples, and the training orchestrator 302 may transmit a control signal to the learner 308 to trigger generation and/or training of one or more machine learning models to support the operative functionality of the system 100, such as to make determinations or predictions relating to the suspiciousness of a URL attempting to be accessed by a user. In certain embodiments, the learner 308 may be activated and may generate one or more models based on the samples and/or features, which may be obtained from feature store 312. In certain embodiments, the learner 308 may train an existing model or train a new model using the samples and/or features. In certain embodiments, the learner 308 may develop models and then store them in the model registry 314 for future use, such as by the inference pipeline service 208. The learner 308, once the model(s) are generated, may notify the training orchestrator 302 accordingly.

In certain embodiments, componentry of the training pipeline service 210 may be utilized to trigger training of the machine learning models. For example, the CronJob 316 may trigger training of the machine learning models, which may trigger operation of the training orchestrator 302. In certain embodiments, the model monitoring service 318 may monitor model generation and/or training and may trigger training, such as based on the receipt of requests, based on a schedule, randomly, based on desired features, based on desired tasks, or a combination thereof. As machine learning models are generated, trained, and/or tested (e.g., such as on sample datasets), telemetry data relating to the machine learning models and the training pipeline service 210 may be provided to a telemetry agent 320, which may be configured to communicate with a telemetry service 322. In certain embodiments, the telemetry service 322 may be configured to analyze, from the telemetry data, the performance of machine learning models (e.g., how much computing resources they require), the types of decisions or predictions that each machine learning models is capable of performing, the efficiency of the machine learning models, the algorithms utilized by the machine learning models, the versatility of the machine learning models, the time at which machine learning models have been utilized and/or executed, the training history of the learning models, or a combination thereof. Any types of performance or other metrics associated with operation of the training pipeline service 210 may be included in the telemetry data that may be analyzed by the telemetry service 322. In certain embodiments, the telemetry service 322 may be utilized to make recommendations for modifying machine learning models, incorporating new functionality into machine learning models, replace algorithms utilized by the machine learning models, establish requirements for performance of machine learning models, specify an amount of computing resources within which the machine learning models must perform, or a combination thereof. In certain embodiments, the training pipeline service 210 may be configured to provide one or more machine learning models and/or features for use by the inference pipeline service 208, such as when the inference pipeline service 208 receives requests to determine suspiciousness of URLs/FQDNs from the PCP classifier 202.

With regard to the inference pipeline service 208, further details relating to the componentry of the inference pipeline service 208 are shown in FIG. 4. In certain embodiments the inference pipeline service 208 may be communicatively linked to the PCP classifier 202, such as to receive requests to determine suspiciousness of an identifier, such as, but not limited to, an address, URLs, FQDNs, and/or other access mechanisms that a user may be attempting to access to gain access to various online or other resources (e.g., a URL, such as www[.]testurl[.]com/content.htm, which may connect a user to a certain resource (e.g., content or functionality)). In certain embodiments, the inference pipeline service 208 may include, but is not limited to including, an API 420, an inference orchestrator 404, a model development sample generator 304, a feature extractor 406, a predictor 412 (e.g., an AutoML predictor), a feature store 408 (may be the same as feature store 214), a model registry 410 (may be the same as model registry 212), a telemetry agent 414 (may be the same as telemetry agent 320 in certain embodiments), a telemetry service 416 (may be the same as telemetry service 322 in certain embodiments), any other componentry, or a combination thereof.

In certain embodiments, the inference pipeline service 208 may be configured to receive requests to determine whether an identifier, such as, but not limited to, an address, URL, FQDN, and/or other access mechanism and/or resources referenced by the foregoing is suspicious. In certain embodiments, a request(s) may be received by the PCP classifier 202, which may initiate the requests for determination of suspiciousness. In certain embodiments, the requests may be received via an HTTP API or other API that may receive the requests. Upon receipt of a request(s), the API 402 may be utilized to notify the inference orchestrator 404 to operate. In certain embodiments, the inference orchestrator 404 may transmit a control signal to the feature extractor 406, which may extract features (e.g., identifier features) from the identifier, such as, but not limited to, an address, URL, FQDN, and/or other access mechanism associated with the request. Once the features are extracted, the features may be stored by the feature extractor 406 into the feature store 408 for future use. In certain embodiments, if the features were already previously computed (e.g., address, URL, FQDN, and/or other access mechanism), such features may be retrieved from the feature store 408. Once the features are obtained, the inference orchestrator 404 may identify, select, access, and/or obtain one or more machine learning models to facilitate the suspiciousness determination from the model registry 410.

Once the features are computed and/or obtained and the one or more machine learning models are selected, the predictor 412 may be utilized to execute the one or more machine learning models using the features to determine the suspiciousness of the identifier (e.g., address, URL, FQDN, and/or other access mechanism). In certain embodiments, for example, if features of the identifier (e.g., address, URL, FQDN, and/or other access mechanism) have a threshold similarity (or match) with features known to be suspicious, such a similarity may cause the predictor 412 to predict that the identifier (e.g., address, URL, FQDN, and/or other access mechanism) is suspicious. In certain embodiments, the predictor 412 may be configured to generate a suspiciousness score for each determination. In certain embodiments, the score may be based on characteristics associated with the identifier (e.g., address, URL, FQDN, and/or other access mechanism). For example, if the machine learning model determines that a URL of a certain type is associated with theft of financial information or a particular type of malicious attacker the score may be higher than for a URL that is associated with auto-subscription to news articles or more benign type of actor.

Once a prediction or determination is made, the predictor 412 may provide the prediction to the inference orchestrator 404 and/or to other componentry of the inference pipeline service 208. In certain embodiments, the inference pipeline service 208 may generate a response including the determination (or indication) relating to suspiciousness of the identifier (e.g., address, URL, FQDN, and/or other access mechanism) of the request and transmit the response to the PCP classifier 202, which may persist the determination with labels relating to suspiciousness and/or score in the PCP database 204. In certain embodiments, telemetry data relating to the operation of the inference pipeline service 208 may be provided to a telemetry agent 414 (e.g., software), which may provide the telemetry data to a telemetry service 416 for analysis. The telemetry data may include, but is not limited to, a time of execution of one or more machine learning models to make determinations or predictions, an identification of the one or more machine learning models, the amount of execution time for executing the one or more machine learning models, the features utilized, the request provided by the PCP classifier 202, and/or any other data. In certain embodiments, the telemetry service 416 may analyze the telemetry data and transmit signals to the system 100 to modify the one or more models, specify specific computer resource usage, the type of functionality necessary for the models, the types of algorithms needed for the models, requirements for the models, whether componentry and/or functionality of the inference pipeline service 208 needs to be changed, any other actions, or a combination thereof.

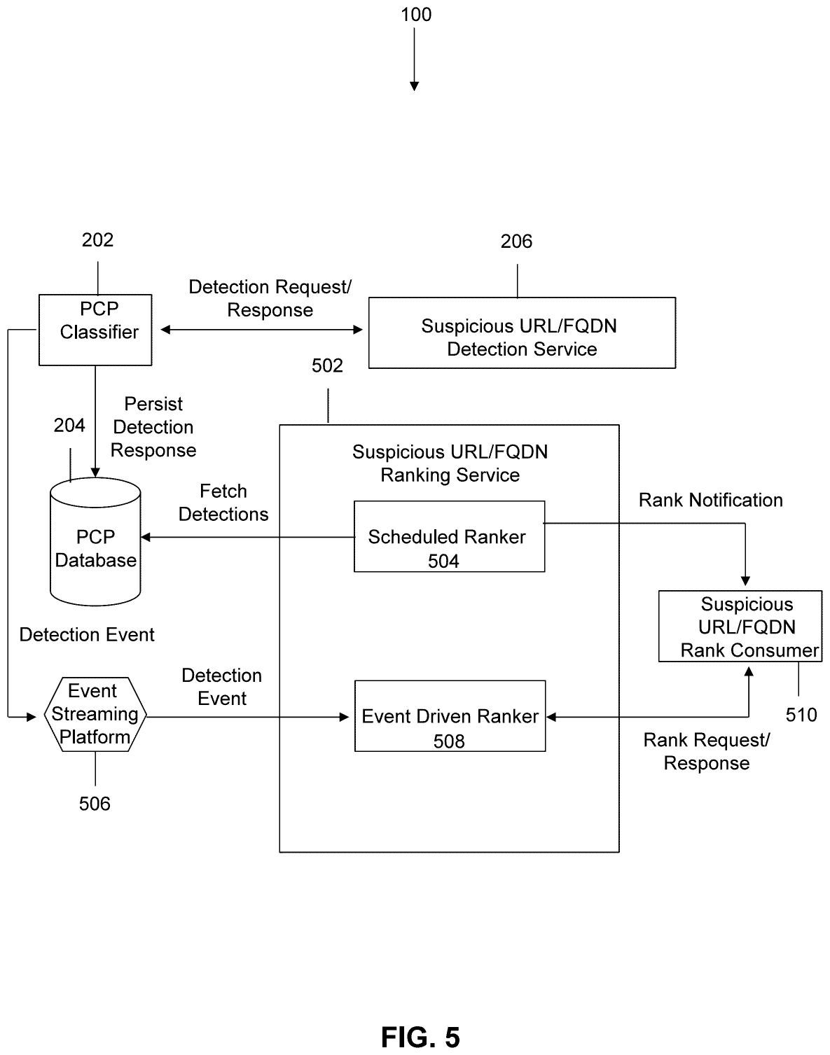

Referring now also to FIG. 5, an exemplary architecture of a suspicious URL/FQDN ranking service 502 for ranking suspicious identifiers (e.g., addresses, URLs, FQDNs, access mechanisms), and/or resources for use with the system 100 according to embodiments of the present disclosure is shown. In certain embodiments, as the suspicious URL/FQDN detection service 206 provides responses in response to requests from the PCP classifier 202, the responses may be labeled (e.g., suspicious or not and/or with any other metadata) and stored in the PCP database 204. In certain embodiments, the suspicious URL/FQDN ranking service 502 may include a plurality of rankers, including a scheduled ranker 504 and an event driven ranker 508. In certain embodiments, the scheduled ranker 504 may be configured to rank identifiers (e.g., addresses, URLs, FQDNs, domains, and/or other access mechanisms), and/or resources relating thereto. In certain embodiments, the scheduled ranker 504 may be configured to run on a schedule (e.g., every few hours or every other day or other interval) and may rank the identifiers (e.g., addresses, URLs, FQDNs, domains, and/or other access mechanisms), and/or resources based on their suspiciousness score. The rankings may be provided via a notification to a suspicious URL/FQDN rank consumer 510, which may store a list of rankings and consume the rankings. In certain embodiments, the event driven ranker 508 may be configured to operate based on events, such as in response to requests for rankings sent by the PCP classifier 202 and/or other componentry of the system 100. The requests may be received by the event streaming platform 506, which may notify the event driven ranker 508. The event drive ranker 508 may be configured to rank identifiers (e.g., addresses, URLs, FQDNs, domains, and/or other access mechanisms), and/or resources based on suspiciousness score and provide the rankings to the suspicious URL/FQDN rank consumer 510 for storage. The rankings may also be provided in a response back to the PCP classifier 202, such as via the event streaming platform 506 and/or other componentry of the system 100. The rankings of identifiers (e.g., addresses, URLs, FQDNs, domains, and/or other access mechanisms), and/or resources may be utilized to adjust how the system 100 reacts to attempts to access identifiers (e.g., addresses, URLs, FQDNs, domains, and/or other access mechanisms), and/or resources. For example, the higher in the list of rankings that a particular URL is, the more restrictive the response may be. As an illustration, the highest ranked identifier may be completed blocked from being accessed and future requests to access the identifier may be preemptively prohibited. However, for an identifier lower on the list, limited access to the resource associated with the identifier may be provided, such as for a fixed duration of time or for only certain types of content.

Although FIGS. 1-5 illustrates specific example configurations of the various components of the system 100, the system 100 may include any configuration of the components, which may include using a greater or lesser number of the components. For example, the system 100 is illustratively shown as including a first user device 102, a second user device 122, a communications network 133, a communications network 134, a communications network 135, a server 140, a server 145, a server 150, a server 160, edge devices 120, 132, a database 155, a PCP classifier 202, a PCP database 204, an automated suspicious URL/FQDN detection system 206, an inference pipeline service 208, a training pipeline service 210, a model registry 212, a feature store 214, a sample store 216, a training orchestrator 302, a model development sample generator 304, a feature extractor 306, an auto machine learning learner 208, a sample store 310, a feature store 312, a model registry 314, a telemetry agent 320, a model monitoring service 318, a telemetry service 322, and/or other componentry. However, the system 100 may include multiple first user devices 102, multiple first user devices 102, multiple second user devices 122, multiple communications networks 133, multiple communications networks 134, multiple communications networks 135, multiple servers 140, multiple servers 145, multiple servers 150, multiple servers 160, multiple edge devices 120, 132, multiple databases 155, multiple PCP classifiers 202, multiple PCP databases 204, multiple automated suspicious URL/FQDN detection systems 206, multiple inference pipeline services 208, multiple training pipeline services 210, multiple model registries 212, multiple feature stores 214, multiple sample stores 216, multiple training orchestrators 302, multiple model development sample generators 304, multiple feature extractors 306, multiple auto machine learning learners 208, multiple sample stores 310, multiple feature stores 312, multiple model registries 314, multiple telemetry agents 320, multiple model monitoring services 318, multiple telemetry services 322, and/or multiple of other componentry, and/or any number of any of the other components inside or outside the system 100. Furthermore, in certain embodiments, substantial portions of the functionality and operations of the system 100 may be performed by other networks and systems that may be connected to system 100.

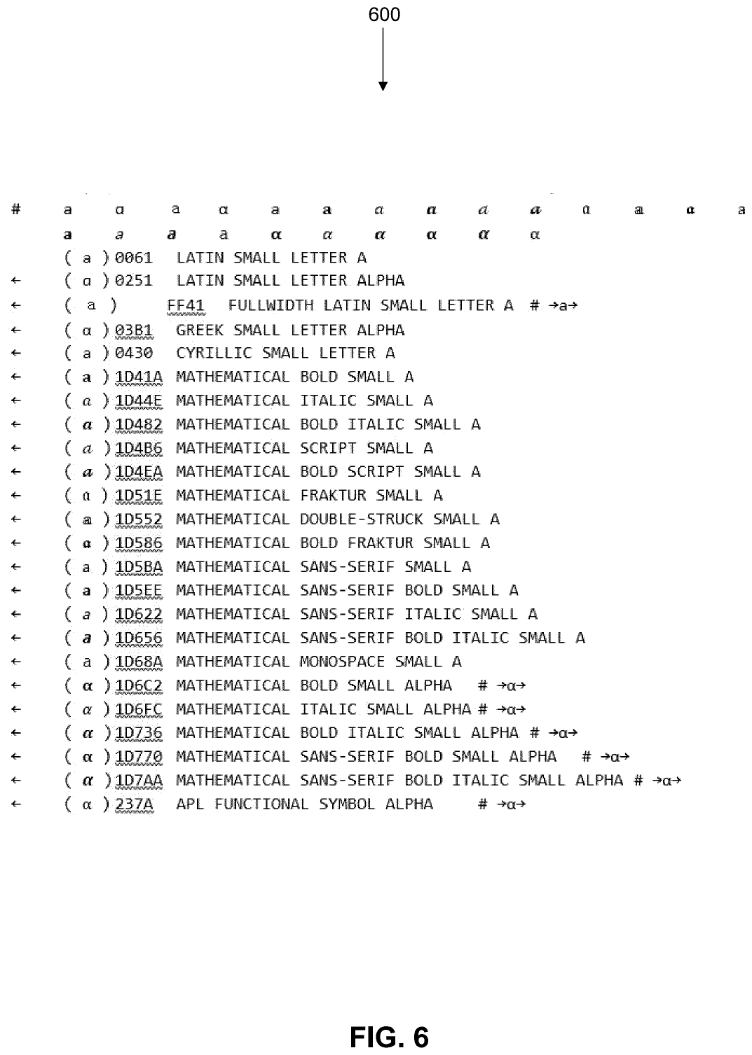

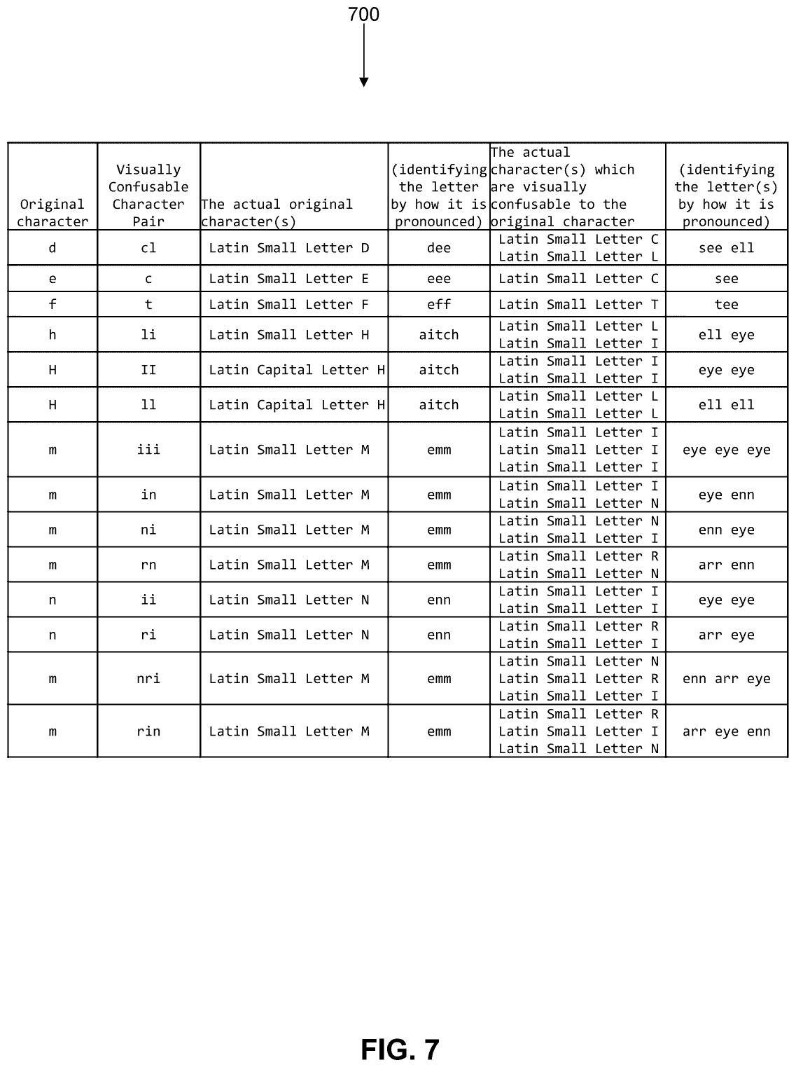

In certain embodiments, the system 100 and methods may incorporate further functionality and features. Notably, the system 100 and methods may be configured to consider a variety of use-case scenarios. An exemplary use-case scenario is in the context of features, such as, but not limited to, confusables, information relating to which is shown in FIGS. 6 and 7. In Unicode there can be many different characters (e.g., code points), which may have glyphs associated with them that look similar to each other. The foregoing creates opportunities for malicious actors to register a domain that visually appears similar to a different domain. As another example, a malicious actor may use these confusable characters within the non-domain parts of a URL in an attempt to deceive a person reading the URL, but to avoid straight-forward comparisons with text strings that may lend a sense of authenticity to a URL. For example, a small section of the “confusablesSummary.txt” available at www[.]unicode[.]org/Public/security/revision-03/confusablesSummary.txt may be examined. As an illustration, for the “Latin Small Letter A”, there are twenty-four different Unicode characters that appear very similar to each other, as shown in the table 600 in FIG. 6. As a result, a malicious actor may have registered a domain atesturl.com (where the first character is the character 0430 CYRILLIC SMALL LETTER A, and not the character 0061 LATIN SMALL LETTER A. Obviously, “atesturl.com” looks similar to “atesturl.com”. However, the foregoing URLs are not the same text string and will not compare as equal, such as when examined by the system 100. As a result, a malicious actor can evade security measures which look for brand impersonation to deceive users into thinking that they are dealing with an authentic entity when, in reality, they are dealing with a website controlled by a malicious actor.

As another example, a malicious actor may also use Unicode confusables in the path portion of a URL. E.g., an attacker may use the URL: https://www[.]attackerexample[.]com/atesturl/security-login/. The word “atesturl” in the path might not be using all of the Unicode Latin Small Letters, but some other Unicode confusables. Indeed, there could be millions, or billions, or even trillions of possible words that use one or more Unicode confusables to look similar to a single word. As a result, a security component which examines the URL may not see a straightforward match with the string “amazon” (which uses all Latin Small Letters). In certain embodiments, for example, a URL may be considered suspicious if the URL contains any characters in the Unicode Confusables list that are not Latin Small Letters or Latin Capital Letters. In certain embodiments, a check by the system 100 may be made to determine whether a URL contains confusably similar strings to a list of authoritative strings. In certain embodiments, for example, a list of authoritative strings could include a list of bank names or the names of payment processing companies. In certain scenarios, a malicious actor can use authoritative strings to deceive a user into thinking that the user is dealing with an authentic website.

As another example, a list of authoritative strings may consist of a list of words associated with concepts, such as “security” or “logon.” In such a scenario, a malicious actor could use confusable Unicode characters to prevent straightforward character matching for detection. In certain embodiments, in order to perform such a check efficiently, the system 100 may generate a copy of the candidate URL for checking by using “canonical” Latin characters (hereafter the “canonical Latin URL copy”). For example, referencing the example above for Unicode confusables for the 0061 LATIN SMALL LETTER A, if any of the characters in the candidate URL are the characters as shown in table 600 of FIG. 6. If so, then in the copy of the candidate URL any such characters may be replaced by 0061 LATIN SMALL LETTER A. In certain embodiments, the copy of the candidate URL (a “canonical Latin URL copy”) may then be checked by the system 100 against a list of authoritative strings efficiently to determine whether there is a match. In certain embodiments, the existence of a match on the canonical Latin URL copy with a list of authoritative strings (i.e., one or more of the authoritative strings occurs within the canonical Latin URL) may raise a suspicion score for the URL. In certain embodiments, a high enough suspicion score may result in a straightforward classification of the URL as suspicious by the system 100

In certain embodiments, the list of possible matches between strings in possibly multiple lists of authoritative strings and the text of the “canonical Latin URL copy” may themselves be features to be used in the system 100 described herein. Lists of authoritative strings can be, for example, a list of names of companies, brands, organizations, governmental agencies, and the like. Lists of authoritative strings may be words that are related to a particular concept. For example, the concept of authentication may have a list that includes the following words: logon, login, signon, signin, log-on, log-in, sign-on, sign-in, logout, log-out, signout, sign-out, logoff, log-off, signoff, sign-off, singlesignon, singlesign-on, single-signon, single-sign-on, sso, password, reset, authenticate, authentication, authorize, authorize, authorization, authorization, auth, authn, authz, register, registration, and/or other related words. In certain embodiments, a URL that contains one or more of the words in the list may appear more authentic and authoritative to a user. This type of deception perpetrated by the malicious actor may be used to entice the user into clicking a link for that URL to arrive at a website under the control of the malicious actor, where the malicious actor may attempt to steal credentials or download malicious software or documents.

In certain embodiments, the system 100 may incorporate and/or utilize any number of lists of authoritative strings for different concepts, such as banking, finance, payments, healthcare, hospitals, insurance, manufacturing, shopping, and/or any other concept. Matches with respect to separate lists of authoritative strings may be used to create separate components of a suspicious score for a URL (which may be subsequently combined with other suspicious scores from other lists, or from other extracted features to create a composite suspicious score which can be used by a security component of the system 100 to allow access to the site at the URL, or to block access to the URL, or to redirect the access to the URL into a security session such as an RBI session (Remote Browsing Isolation), or to trigger a manual and/or automated security investigation of the site at the URL, or a combination thereof), or can themselves may be features used in the determination of suspiciousness process described in the present disclosure.

In certain scenarios, there may be several other notions similar to Unicode confusables that deal with a different type of visual confusion that an attacker might use. For example, another type is “confusable Latin characters” and a further type is “kerning confusables.” With regard to confusable Latin characters, malicious actors may attempt to deceive users by the visual confusion that can occur between different Latin characters. For example, the Latin Small Letter L “1” and the Latin Digit 1 “1”, or the Latin Small Letter “z” and the Latin Digit “2”, the Latin Capital Letter “B” and the Latin Digit “8”. There may be any number of other single character (or multiple character) confusions. This foregoing may be handled in the same way as described above for using a “canonical Latin URL copy”. In certain embodiments, the system 100 may utilize a table of single character Latin character confusables to create a “canonical Latin confusables URL copy” in which, for example, whenever the digit “1” is encountered the digit is canonically replaced by the Latin Small Letter L “l”, and so forth. The canonical approach may enable efficient matching, and the generation of resultant suspicious scores, or the generation of features for use by the system 100 as described herein.

With regard to kerning confusables, malicious actors may use confusion of adjacent lower case characters to look like different characters. E.g., “bankofarnerica” could be confused with “bankofamerica” visually. The former has the letters “r” and “n” positioned adjacent to each other, which can be visually confused with the letter “m”. Such a scenario may constitute a “kerning confusable.” An exemplary table of example kerning confusables is shown in the table 700 of FIG. 7. Thus, in a manner similar to how the technique described above that involves creating a “canonical Latin URL copy” to enable efficient comparison to any number of lists of authoritative terms, using the kerning confusables may be used to create a “canonical kerning confusables URL copy” for matching by the system 100. The foregoing capability reveals deceptions used by malicious actors using the kerning confusables techniques. In certain embodiments, the system 100 may detect matches against lists of authoritative strings that can be used to generate additional features to be used in the machine learning models, or may be used directly to create additional components of a suspicious URL score.

In certain embodiments, the system 100 may be utilized for error correcting matches for canonical URLs (or other identifiers, such as FQDNs, addresses, etc.). As described in the present disclosure, the system 100 may enable a matching process to determine whether a canonical form of the URL contains terms from one or more lists of authoritative strings. For example, the system 100 may look for any exact matches of terms from the lists within the canonical form of the URL. However, a malicious actor may have gone further in their attempt to deceive a user, and in addition to using confusables, the malicious actor may be using typographical changes, substitutions, and/or insertions, and/or deletions. In certain embodiments, an edit distance to compute the distance between two strings in terms of the number of (e.g., possibly weighted sum) edit operations (e.g., insert a character, delete a character, substitute a character, transpose two characters). In certain embodiments, any of the preceding comparisons of any sort of canonical form of a URL may utilize the edit distance to consider not just exact matches, but also matches which are a configurable amount of edit distance away from each other. For example, an acceptable match may be an edit distance that is less than or equal to one quarter of the length to the matched string in the canonical form a URL or the matched string in an authoritative list. The foregoing may be used to create suspicious score components (which are combined to yield a composite “suspicious score”). In certain embodiments, the foregoing may be used to generate additional features for use in a machine learning process of the system 100.

Another scenario that the system 100 may be utilized to thwart malicious actors is enabling the system 100 to factor the type of device on which a URL (or other identifiers, such as FQDN, link, address, or other access mechanism) is displayed. For example, the type of device (e.g., a mobile device where it may be more difficult to read a complete URL, where it may be more difficult to detect an attacker's use of a Unicode confusable) may be an additional feature factored by the system 100 described above. For example, there maybe more risk if the candidate URL is viewed on a mobile device versus a desktop device, where the complete URL may be more readily viewed or perceived.

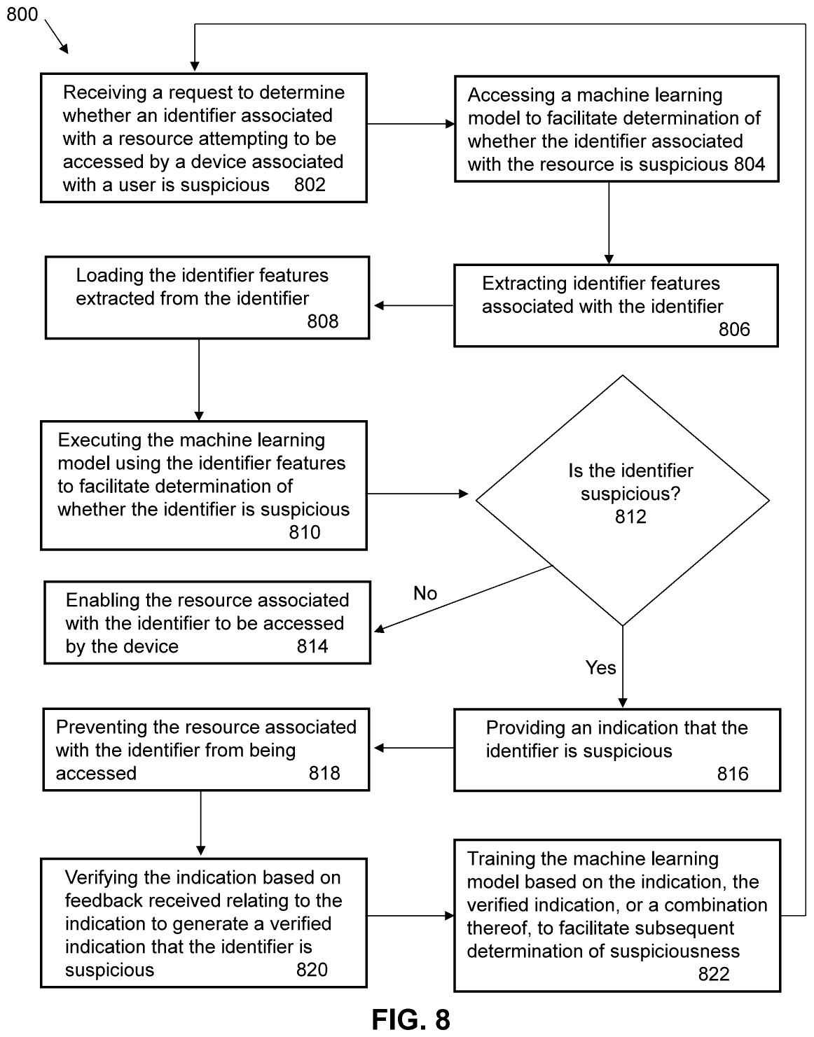

Referring now also to FIG. 8, FIG. 8 illustrates an exemplary method 800 for providing automated detection of suspicious identifiers (e.g., URLs, FQDNs, etc.) according to embodiments of the present disclosure. In certain embodiments, the method of FIG. 8 can be implemented in the system 100 of FIGS. 1-6 and/or any of the other systems, devices, and/or componentry illustrated in the Figures. In certain embodiments, the method of FIG. 8 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 8 may be performed at least in part by one or more processing devices (e.g., processor 102, processor 122, processor 141, processor 146, processor 151, and processor 161 of FIG. 1) and/or other devices, systems, components, or a combination thereof, of FIGS. 2-5. Although shown in a particular sequence or order, unless otherwise specified, the order of the steps in the method 800 may be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Generally, the method 800 may include steps for providing automated detection of suspicious identifiers. Notably, the method 800 may include steps for receiving request to determine whether an identifier (e.g., an address, URL, FQDN, and/or other access or input mechanism) associated with a resource attempting to be accessed by a device is suspicious. In certain embodiments, the method 800 may include accessing an optimal machine learning model to facilitate determination regarding suspiciousness of the identifier. The method 800 may include computing and/or loading identifier features extracted from the identifier. In certain embodiments, the method 800 may include executing the machine learning model using identifier features to facilitate determination regarding suspiciousness of the identifier. If the identifier is not suspicious, the method 800 includes enabling the identifier and referenced resource to be accessed by the device. If, however, the identifier is determined to be suspicious, the method 800 may include providing an indication that the identifier is suspicious. In certain embodiments, the method 800 may include verifying the indication, such as based on feedback by experts or other systems. If the identifier is verified to be suspicious, the method 800 may prevent the resource associated with the identifier from being accessed and/or notify the device attempting to access the resource that the identifier is suspicious. In certain embodiments, the method 800 may include training the machine learning model and/or other machine learning models based on the indication, the verified indication, or a combination thereof, to facilitate subsequent determinations of suspiciousness for other requests that arrive.

At step 802, the method 800 may include receiving a request(s) to determine whether an identifier (e.g., address, URL, FQDN, link, or other access mechanism) associated with a resource attempting to be accessed by a device (e.g., first user device 102) associated with a user (e.g., first user 101) is suspicious. In certain embodiments, any number of requests may be received and the requests may be provided by a client, such as a PCP classifier 202, to the automated suspicious URL/FQDN detection system 206. In certain embodiments, when a request is received, the inference pipeline service 208 may be activated for operation. In certain embodiments, the receiving of the request(s) may be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device. At step 804, the method 800 may include accessing and/or obtaining a machine learning model to facilitate determination of whether the identifier associated with the resource is suspicious. In certain embodiments, an optimal machine learning model may be obtained from a model registry 212 by the inference pipeline service 208 that has a capability for detecting suspiciousness for the particular identifier (e.g., address, URL, FQDN, or other access mechanism). In certain embodiments, the accessing and/or the obtaining may be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device.

At step 806, the method 800 may include computing and/or extracting identifier features from the identifier associated with the resource. In certain embodiments, for example, the identifier features may be computed from the identifier itself, however, in certain embodiments, the identifier features may be computed from sample addresses having a correlation to the address. In certain embodiments, the features may comprise any type of features (e.g., of the identifier and/or resource, applications, systems, and/or devices that the identifier points to or references) and may include, but are not limited to, lexical features (e.g., length of identifier, length of top level domain, length of primary domain, length of hostname, length of path, number of vowels, number of consonants, whether the IP address is used as the domain name, number of non-alphanumeric characters, etc.), file name features (e.g., length of file name to be accessed, number of detainers, etc.), directory-related features (e.g., length of directory, number of sub-directory tokens, etc.), the Kolmogrov Complexity or the Shannon Entropy of an address string, bag-of-word features, etc.), host-based features (e.g., WHOIS information (e.g., domain name registration date, information relating to the registrar, information about the registrant), domain name properties (e.g., time-to-live (TTL) values from a domain registration date), geographic properties (e.g., location of the IP address), content-based features (e.g., presence of HTML forms, presence of <input> tags, presence of keywords may ask users to provide credit card information, password, social security number etc., length of HTML form, length of <style>, length of <script>, length of the whole document, average length of words, word count, distinct word count, number of words in text, number of words in title, number of images, number of iframes, number of zero size iframes, number of hyperlinks, link to remote source of script, number of null characters, usage of string concatenation, number of times domain names appear in the HTML content, number of unique subdomains (of primary domain of the URL) is present in the HTML content, number of unique directory paths for all referenced files in the HTML content, Javascript features (e.g., extensive usage of eval( ), extensive usage of unescape( ), number of long strings, number of event attachments, number of “iframe” strings), any use of non-alphanumeric Javascript obfuscation (as described, e.g., in the book “Web Application Obfuscation” by Mario Heiderich, Eduardo Alberto Vela Nava, Gareth Heyes, David Lindsay),webpage screenshot-based features (e.g., earth mover's distance between images, contrast context histogram features, scale invariant feature transform features, deep learning based features of images), character features (e.g., characters in the identifier), features relating to the edit distance between strings and/or characters in the identifier, HTML content in the identifier features, other features, or a combination thereof. In certain embodiments, the computing of the features (e.g. identifier features) may be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device.

At step 808, the method 800 may include loading the identifier features extracted from the identifier associated with the resource (and/or the resource to which the identifier refers to). In certain embodiments, if the identifier features (or features having a similarity to the identifier features) already existed in the system 100, step 806 may have been skipped, and the method 800 may have proceed from step 804 directly to step 808. In certain embodiments, the identifier features may be loaded from the feature store 214 into the inference pipeline service 208, and, in certain embodiments, may be directly provided to the inference pipeline service 208 after computation of the features. In certain embodiments, the loading of the identifier features may be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device. At step 810, the method 800 may include executing the machine learning model using the identifier features to facilitate determination of whether the identifier is suspicious. In certain embodiments, the executing of the machine learning model to facilitate the determination of suspiciousness may be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device.

At step 812, the method 800 may include determining if the identifier is suspicious based on execution of the machine learning model and identifier features. In certain embodiments, the determining may be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device. If, at step 812, the identifier is determined to not be suspicious, the method 800 may proceed to step 814. At step 814, the method 800 may include enabling the resource associated with the identifier to be accessed by the device attempting to access the resource via the identifier. In certain embodiments, the enabling may be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device.

If, however, at step 812, the identifier is determined to be suspicious, the method 800 may proceed to step 816. At step 816, the method 800 may include providing an indication that the identifier is suspicious. For example, the indication may be included in a response that indicates that the identifier that is the subject of the request from the PCP classifier 202 is suspicious. In certain embodiments, for example, the inference pipeline service 208 may be configured to provide the response including the indication to the PCP classifier 202. In certain embodiments, the providing of the indication performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device. At step 818, the method 800 may include preventing the resource associated with the identifier from being accessed. In certain embodiments, the method 800 may also include preventing interaction with an identifier determined to be suspicious. In certain embodiments, the preventing may be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device.

In certain embodiments, for example, the system 100 may transmit a notification to the device indicating that the identifier is suspicious and automatically redirect the device to a different identifier and/or resource. In certain embodiments, the user may be prompted to change the identifier or access a different resource. In certain embodiments, the preventing of the accessing of the resource may be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device. At step 820, the method may include verifying the indication that the identifier is suspicious, such as based on feedback received relating to the indication to generate a verified indication that the identifier is suspicious. In certain embodiments, the verifying may be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device. At step 822, the method 800 may include training the machine learning model and/or other machine learning models based on the indication, the verified indication, or a combination thereof, to facilitate subsequent determinations of suspiciousness for addresses (or URLs, FQDNs, links, and/or other access or input mechanisms).

In certain embodiments, the method 800 may be repeated as desired, which may be on a continuous basis, periodic basis, or at designated times. Notably, the method 800 may incorporate any of the other functionality as described herein and may be adapted to support the functionality of the system 100. In certain embodiments, functionality of the method 800 may be combined with other methods and/or functionality described in the present disclosure. In certain embodiments, certain steps of the method 800 may be replaced with other functionality of the present disclosure and the sequence of steps may be adjusted as desired.

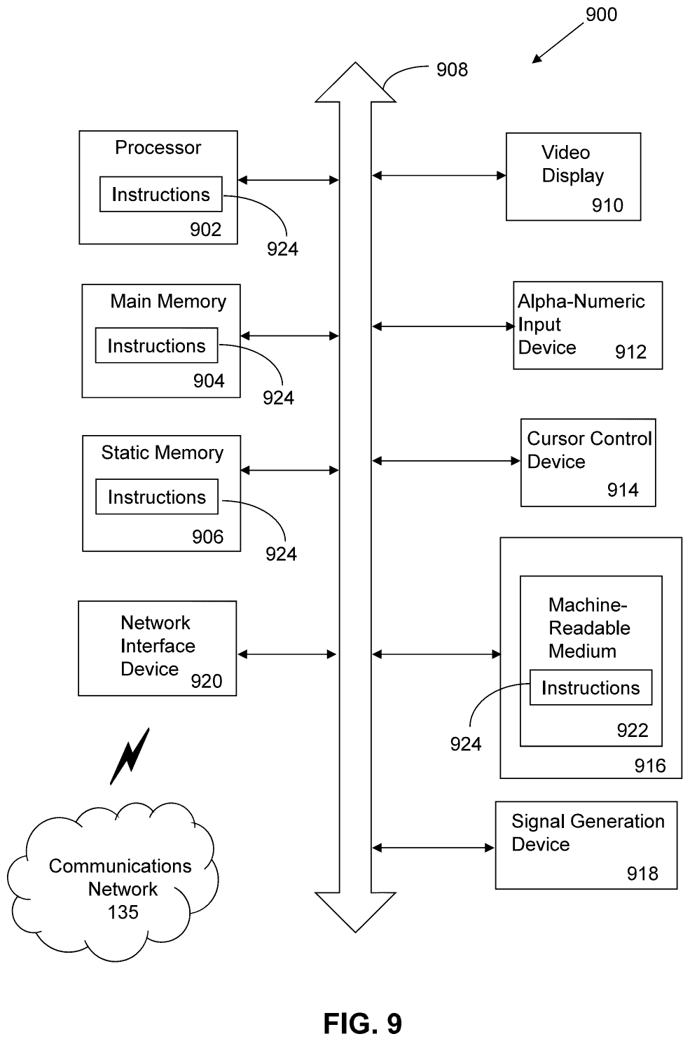

Referring now also to FIG. 9, at least a portion of the methodologies and techniques described with respect to the exemplary embodiments of the system 100 and/or method 800 can incorporate a machine, such as, but not limited to, computer system 900, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100. As another example, in certain embodiments, the computer system 900 may assist in receiving requests to determine whether an identifier (e.g., an address, link, URL, FQDN and/or other interactable mechanism) for accessing resources (e.g., web pages, applications, content, etc.) is suspicious; accessing and/or obtaining machine learning models to determine whether the identifier (e.g., address, link, URL, FQDN, and/or other interactable mechanism) is suspicious; loading a plurality of features extracted from the identifier; determining whether the identifier (e.g., address, link, URL, FQDN, and/or other interactable mechanism) is suspicious based on execution of the machine learning model using the loaded features; providing an indication that the identifier (e.g., address, link, URL, FQDN, and/or other interactable mechanism) is suspicious; verifying that the indication based on feedback relating to the indication to generate a verified indication that the identifier is suspicious; outputting the verified indication; training models based on the verified indication; preventing access to resources for which the indication indicates that the identifier (e.g., address, link, URL, FQDN, and/or other interactable mechanism) is suspicious; and/or performing any other operations of the system 100.

In some embodiments, the machine may operate as a standalone device. In some embodiments, the machine may be connected (e.g., using communications network 135, another network, or a combination thereof) to and assist with operations performed by other machines and systems, such as, but not limited to, the first user device 102, the second user device 122, the communications network 133, the communications network 135, the server 140, the server 145, the server 150, the server 160, edge devices 120, 132, the database 155, the PCP classifier 202, the PCP database 204, the automated suspicious detection system 206, the inference pipeline service 208, the training pipeline service 210, any other system, program, and/or device, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 900 may include a processor 902 (e.g., a central processing unit (CPU), a graphics processing unit (GPU, or both), a main memory 904 and a static memory 906, which communicate with each other via a bus 908. The computer system 900 may further include a video display unit 910, which may be, but is not limited to, a liquid crystal display (LCD), a flat panel, a solid-state display, or a cathode ray tube (CRT). The computer system 900 may include an input device 912, such as, but not limited to, a keyboard, a cursor control device 914, such as, but not limited to, a mouse, a disk drive unit 916, a signal generation device 918, such as, but not limited to, a speaker or remote control, and a network interface device 920.

The disk drive unit 916 may include a machine-readable medium 922 on which is stored one or more sets of instructions 924, such as, but not limited to, software embodying any one or more of the methodologies or functions described herein, including those methods illustrated above. The instructions 924 may also reside, completely or at least partially, within the main memory 904, the static memory 906, or within the processor 902, or a combination thereof, during execution thereof by the computer system 900. The main memory 904 and the processor 902 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 922 containing instructions 924 so that a device connected to the communications network 133, the communications network 135, another network, or a combination thereof, can send or receive voice, video or data, and communicate over the communications network 135, another network, or a combination thereof, using the instructions. The instructions 924 may further be transmitted or received over the communications network 133, the communications network 135, another network, or a combination thereof, via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

1. A system, comprising:
a memory storing instructions; and
a processor configured to execute the instructions to cause the processor to be configured to:
receive a request to determine whether an identifier associated with a resource attempting to be accessed by a device associated with a user is suspicious;
access, in response to the request, a machine learning model to facilitate determination of whether the identifier associated with the resource is suspicious;
load identifier features extracted from the identifier associated with the resource attempting to be accessed;
determine a suspiciousness score for the identifier associated with the resource attempting to be accessed by the device;
determine whether the identifier associated with the resource attempting to be accessed is suspicious based on execution of the machine learning model using the identifier features and based on the suspiciousness score; and
provide, in response to the request, an indication of the suspiciousness score for the identifier and whether the identifier is suspicious.

2. The system of claim 1, wherein the processor is further configured to determine a context associated with suspiciousness of the identifier based on the suspiciousness score.

3. The system of claim 1, wherein the processor is further configured to reject the indication if feedback received relating to the indication does not verify the indication that the identifier is suspicious, confirms that the identifier is not suspicious, or a combination thereof.

4. The system of claim 3, wherein the processor is further configured to:
assign a label to the identifier to provide a labeled identifier indicating that the identifier is not suspicious if the indication is rejected.

5. The system of claim 1, wherein the processor is further configured to automatically select the machine learning model from a plurality of machine learning models to facilitate determination of whether the identifier associated with the resource is suspicious based on a type of the identifier, based on a type of the resource, based on an identity of the user, based on the identifier features extracted from the identifier, or a combination thereof.

6. The system of claim 1, wherein the processor is further configured to:
activate an inference pipeline service in response to the request; and
transmit, by utilizing an inference orchestrator of the inference pipeline service, a control signal to cause a feature extractor to extract the identifier features from the identifier.

7. The system of claim 1, wherein the processor is further configured to:
activate a training pipeline service; and
activate, by utilizing a training orchestrator of the training pipeline service, a model development sample generator configured to:
obtain a labeled dataset including data labeled as suspicious or not suspicious;
generate a plurality of samples from the labeled dataset; and
transmit a notification to the training orchestrator indicating that the plurality of samples have been generated.

8. The system of claim 7, wherein the processor is further configured to:
transmit, by utilizing the training orchestrator of the training pipeline service, a control signal to cause a feature extractor to obtain the plurality of samples;
extract, by utilizing the feature extractor, features from the plurality of samples; and
transmit a notification to the training orchestrator indicating that the features have been extracted from the plurality of samples.

9. The system of claim 8, wherein the processor is further configured to:
train, by utilizing a learner of the training pipeline service, the machine learning model using the features, the plurality of samples, or a combination thereof; and
store the machine learning model in a model registry.

10. The system of claim 1, wherein the processor is further configured to:
monitor the machine learning model utilizing a model monitoring service; and
trigger, by utilizing the model monitoring service, training of the machine learning model based on a schedule, based on the request, based on a task to be performed by the machine learning model, or a combination thereof.

11. The system of claim 1, wherein the processor is further configured to:
generate a recommendation for modifying the machine learning model based on telemetry data generated based on operation of the machine learning model; and
modify the machine learning model based on the recommendation.

12. The system of claim 1, wherein the processor is further configured to rank the identifier relative to a plurality of other ranked identifiers based on the suspiciousness score calculated for the identifier and suspiciousness scores calculated for the plurality of other ranked identifiers.

13. A method, comprising:
receiving a request to determine whether an identifier associated with a resource attempting to be accessed by a device associated with a user is suspicious;
selecting, in response to the request, a machine learning model to facilitate determination of whether the identifier associated with the resource is suspicious;
loading identifier features extracted from the identifier associated with the resource attempting to be accessed;
determining a suspiciousness score for the identifier associated with the resource attempting to be accessed by the device;
determining, by utilizing instructions from a memory that are executed by a processor, whether the identifier associated with the resource attempting to be accessed is suspicious based on execution of the machine learning model using the identifier features and based on the suspiciousness score; and
providing, in response to the request, an indication of the suspiciousness score for the identifier and whether the identifier is suspicious.

14. The method of claim 13, further comprising confirming performance of the machine learning model based on feedback verifying the indication, an accuracy of the indication, a speed of the machine learning model in determining whether the identifier is suspicious, an uptime of the machine learning model, or a combination thereof.

15. The method of claim 13, further comprising assigning a label to the identifier, wherein the label indicates the suspiciousness score, a type of malicious attack associated with the identifier, an identity of a malicious actor associated with the identifier, or a combination thereof.

16. The method of claim 13, further comprising increasing the suspiciousness score for the identifier if the identifier matches a string in a list of authoritative strings.

17. The method of claim 13, further comprising:
redirecting the device of the user to a different resource if the identifier associated with the resource is determined to be suspicious.

18. The method of claim 17, further comprising identifying a type of malicious attack associated with the identifier if the identifier is determined to be suspicious.

19. A system, comprising:
a memory storing instructions; and
a processor configured to execute the instructions to cause the processor to be configured to:
obtain labeled datasets that comprise data verified as suspicious or not suspicious;
extract training features from the labeled datasets;
train machine learning models using the training features extracted from the labeled datasets;
receive a request to determine whether an identifier associated with a resource attempting to be accessed by a device associated with a user is suspicious;
access, in response to the request, at least one machine learning model to facilitate determination of whether the identifier associated with the resource is suspicious;
load identifier features extracted from the identifier associated with the resource attempting to be accessed;
determine a suspiciousness score for the identifier associated with the resource attempting to be accessed by the device;
determine whether the identifier associated with the resource attempting to be accessed is suspicious based on execution of the machine learning model and based on the suspiciousness score; and
provide, in response to the request, an indication of the suspiciousness score for the identifier and whether the identifier is suspicious.

20. The system of claim 19, wherein the processor is further configured to adjust a level of access to the resource based on the suspiciousness score.
